(19) United States
(12) Patent Application Publication
(10) Pub. No.: US 2020/0028397 A1
(43) Pub. Date: Jan. 23, 2020

(54) ROTATING ELECTRICAL MACHINE

(71) Applicant: AISIN SEIKI KABUSHIKI KAISHA, Kariya-shi (JP)

(72) Inventors: Masafumi SAKUMA, Chiryu-shi (JP); Teppei TSUDA, Nagoya-shi (JP)

(73) Assignee: AISIN SEIKI KABUSHIKI KAISHA, Kariya-shi (JP)

(21) Appl. No.: 16/419,061

(22) Filed: May 22, 2019

(30) Foreign Application Priority Data
Jul. 20, 2018 (JP) 2018-136735

(51) Int. Cl. H02K 3/28; H02K 1/16; H02K 1/27; H02K 21/14

(52) U.S. Cl. CPC H02K 3/28; H02K 21/14; H02K 1/276; H02K 1/16

(57) ABSTRACT

A rotating electrical machine includes a stator including a plurality of slots on which conductive wire is wound, and a rotor facing the stator and including a plurality of magnetic poles, wherein the rotating electrical machine is configured of fractional slot in which a denominator of an irreducible fraction obtained by dividing a number of the slots of the stator by a number of phases and a number of the magnetic poles of the rotor is equal to or greater than four, and ratio of magnitude of magnetomotive force of each phase is even in respective poles of the magnetic poles of the rotor.

### CROSS REFERENCE TO RELATED APPLICATIONS

This application is based on and claims priority under 35 U.S.C. § 119 to Japanese Patent Application 2018-136735, filed on Jul. 20, 2018, the entire content of which is incorporated herein by reference.

### TECHNICAL FIELD

This disclosure generally relates to a rotating electrical machine configured of fractional slot in which the number of slots of a stator per pole per phase is a fraction.

### BACKGROUND DISCUSSION

Conventionally, a rotating electrical machine is known which is configured of fractional slot in which a denominator of an irreducible fraction (the number of slots per pole per phase) equals to four or greater than four, the irreducible fraction is obtained by dividing the number of slots of a stator by the number of phases and the number of poles of a rotor (for example, refer to JP2016-5409A which will be hereinafter referred to as Patent reference 1).

Patent reference 1 discloses a three-phase alternating current electric motor including four poles and fifteen slots or including ten poles and thirty-six slots, in which an irreducible fraction is 5/4 and 6/5, respectively. Coil of the three-phase alternating current electric motor is configured by double-layer-winding including a predetermined coil pitch, and a placement or alignment of a second layer is shifted or offset by a predetermined number of slots relative to a first layer. The technique of Patent reference 1 corresponds to reducing torque ripple, by calculating the predetermined number of slots from a relational expression defined on the basis of the number of pairs of poles and the number of slots.

On a rotating electrical machine configured of fractional slot, due to a magnetic configuration of the rotating electrical machine, an exciting force of a space deformation mode including an order which is less than the number of poles of a rotor is generated. A stator includes a natural frequency that corresponds to the space deformation mode, and the lower the order of the space deformation mode is, the smaller the natural frequency is. In a case where a frequency of the exciting force of the low-order space deformation and the natural frequency of the stator that corresponds to the low-order space deformation mode match each other, resonance occurs, and noise and vibration increase. Accordingly, on the rotating electrical machine configured of the fractional slot, the noise and vibration increase in a range of a low number of revolutions.

In a case where the arrangement or alignment of the second layer is shifted relative to the first layer by the predetermined number of slots as in Patent reference 1, ratio of magnitude of the exciting force generated by coil sides which are accommodated in plural slots continuously adjacent to each other in a circumferential direction of the rotor and which include the same phase and the same direction of electric current as each other is uneven or non-uniform along the circumferential direction of the rotor. For example, in an example of four poles and fifteen slots that is exemplified in Patent reference 1, the ratio of magnitude of the exciting force changes as 3:2:2:3, and thus a magnetic attractive force acting between the rotor and the stator becomes uneven along the circumferential direction of the rotor. As a result, the exciting force of the space deformation mode including a lower order than the number of poles (four poles) of the rotor occurs more easily, and thus the noise and vibration increase in a range of low number of revolutions in which a natural frequency of the stator that corresponds to the low-order space deformation mode and a frequency of the exciting force of the low-order space deformation match with each other. That is, in a case where the rotating electrical machine as described above is applied for driving an electric vehicle and a hybrid vehicle, a vehicle speed range in which the noise and vibration increases becomes lower. Therefore, in a case where the rotating electrical machine as described above is operated on the electric vehicle and/or the hybrid vehicle for driving such vehicles, the vehicle speed range in which the noise and vibration increases comes close to a range of low vehicle speed in which the vehicle is often driven. This increases frequency of opportunities in which the noise and vibration increases.

A need thus exists for a rotating electrical machine which is not susceptible to the drawback mentioned above.

### SUMMARY

According to an aspect of this disclosure, a rotating electrical machine includes a stator including a plurality of slots on which conductive wire is wound, and a rotor facing the stator and including a plurality of magnetic poles, wherein the rotating electrical machine is configured of fractional slot in which a denominator of an irreducible fraction obtained by dividing a number of the slots of the stator by a number of phases and a number of the magnetic poles of the rotor is equal to or greater than four, and ratio of magnitude of magnetomotive force of each phase is even in respective poles of the magnetic poles of the rotor.

According to another aspect of this disclosure, a rotating electrical machine includes a stator including a plurality of slots on which conductive wire is wound, and a rotor facing the stator and including a plurality of magnetic poles, wherein the rotating electrical machine is configured of fractional slot in which a denominator of an irreducible fraction obtained by dividing a number of the slots of the stator by a number of phases and a number of the magnetic poles of the rotor is equal to or greater than four, and ratio of magnitude of magnetomotive force of each pole coil of each phase is even in a circumferential direction of the rotor.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is an enlarged cross-sectional view of part of a motor of an embodiment disclosed here;

FIG. 2 is a schematic view illustrating an example of a configuration of a unit coil according to the embodiment;

FIG. 3 is a schematic view illustrating an example of a phase arrangement of eight poles and thirty slots according to the embodiment;

FIG. 4 is a schematic view illustrating another example of a phase arrangement of eight poles and thirty slots according to the embodiment;

FIG. 5 is a schematic view illustrating a comparative example of a phase arrangement of eight poles and thirty slots;

FIG. 6 is a schematic view illustrating another example of a phase arrangement of eight poles and thirty slots according to the embodiment;

FIG. 7 is a schematic view illustrating another example of a phase arrangement of eight poles and thirty slots according to the embodiment;

FIG. 8 is a schematic view illustrating a comparative example of a phase arrangement of eight poles and thirty slots;

FIG. 9 is a schematic view illustrating an example of a phase arrangement of eight poles and forty-two slots according to the embodiment;

FIG. 10 is a schematic view illustrating another example of a phase arrangement of eight poles and forty-two slots according to the embodiment;

FIG. 11 is a schematic view illustrating a comparative example of a phase arrangement of eight poles and forty-two slots;

FIG. 12 is a schematic view illustrating another example of a phase arrangement of eight poles and forty-two slots according to the embodiment;

FIG. 13 is a schematic view illustrating another example of a phase arrangement of eight poles and forty-two slots according to the embodiment;

FIG. 14 is a schematic view illustrating a comparative example of a phase arrangement of eight poles and forty-two slots;

FIG. 15 is a schematic view illustrating an example of a phase arrangement of ten poles and thirty-six slots according to the embodiment;

FIG. 16 is a schematic view illustrating a comparative example of a phase arrangement of ten poles and thirty-six slots;

FIG. 17 is a schematic plan view illustrating an example of double-layer winding of eight poles and thirty slots according to the embodiment;

FIG. 18 is a schematic lateral view illustrating an example in which coil is wound in the double-layer-winding way on a motor including eight poles and thirty slots according to the embodiment;

FIG. 19 is a schematic plan view illustrating an example in which the coil is wound in the double-layer-winding way on the motor including eight poles and thirty slots according to the embodiment;

FIG. 20 is a schematic plan view illustrating a comparative example in which coil is wound in the double-layer-winding way on the motor including eight poles and thirty slots;

FIG. 21 is a schematic plan view comparing double-layer-winding of the coil at a motor in which an irreducible fraction is 3/2;

FIG. 22 is a schematic plan view comparing double-layer-winding of the coil at a motor in which an irreducible fraction is 5/2;

FIG. 23 is a schematic plan view in which the coils are connected in series at a motor including eight poles and thirty slots according to the embodiment;

FIG. 24 is a schematic plan view in which coils are connected in series at a motor including eight poles and thirty slots according to a comparative example;

FIG. 25 is a schematic plan view in which the coils are connected in parallel at the motor including eight poles and thirty slots according to the embodiment;

FIG. 26 is a schematic plan view in which the coils are connected in parallel at the motor including eight poles and thirty slots according to the embodiment;

FIG. 27 is a schematic plan view in which coils are connected in parallel at a motor including eight poles and thirty slots according to a comparative example; and

FIG. 28 is a schematic plan view in which coils are connected in parallel at a motor including eight poles and thirty slots according to a comparative example.

### DETAILED DESCRIPTION

An embodiment of a rotating electrical machine disclosed here will be described hereunder with reference to the drawings. In the embodiment, the explanation will be made on a three-phase alternating current synchronous electric motor (which will be referred to as a motor M) serving as an example of the rotating electrical machine. The present disclosure, however, is not limited to the embodiment and may be changed and modified in various ways without departing from the scope of the disclosure.

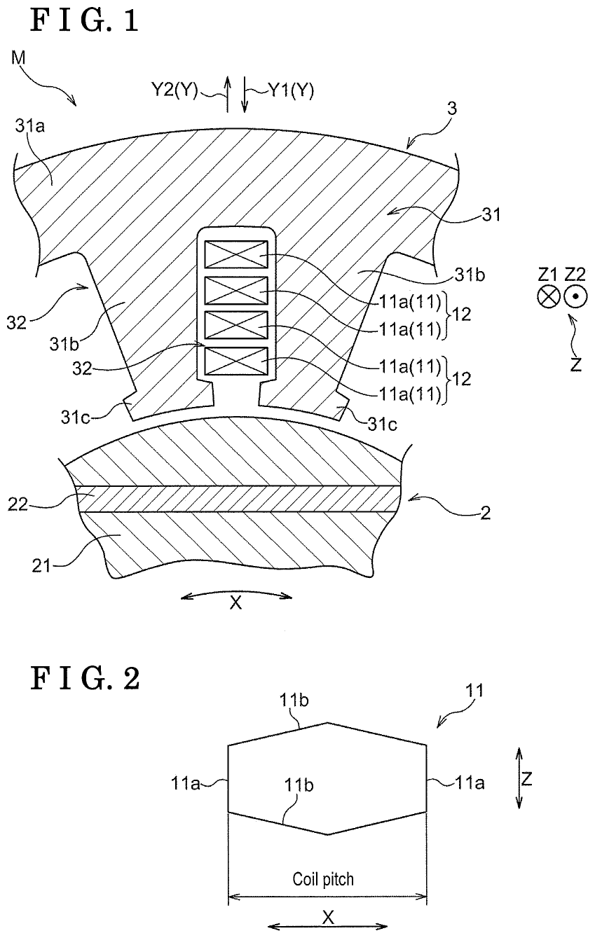

(Basic configuration) As illustrated in FIG. 1, the motor M includes a stator 3 including plural slots 32 on which conductive wire (which will be referred to as winding) is wound, and a rotor 2 facing the stator 3 and including plural permanent magnets 22 (an example of magnetic pole). In the following explanation, a rotational direction and the reverse rotational direction of the rotor 2 are referred to as a circumferential direction X, a radial direction of the rotor 2 is referred to as a radial direction Y, and a direction which is apparel to a rotational axis of the rotor 2 is referred to as an axial direction Z. In the radial direction Y, a direction from the stator 3 towards the rotor 2 (that is, an opening side of the slot 32) is referred to as a radially inward direction Y1 and a direction from the rotor 2 towards the stator 3 (that is, a bottom portion side of the slot 32) is referred to as a radially outward direction Y2. In the axial direction Z, a direction from a front side of the paper surface on which FIG. 1 is drawn towards a back side of the paper surface is referred to as an axial rear direction Z1, and a direction from the back side of the paper surface towards the front side of the paper surface is referred to as an axial front direction Z2.

The stator 3 includes a stator core 31 including a cylindrical shape. The stator core 31 is formed of plural magnetic steel sheets laminated or stacked each other. The stator core 31 is configured of a yoke portion 31a formed in an annular shape at the radially outward direction Y2 side, plural teeth portions 31b protruding from the yoke portion 31 in the radially inward direction Y1, and a flange portion 31c provided at a protruding end of each of the plural teeth portions 31b to be arranged along the circumferential direction X. The slot 32 on which the winding is wound is formed between the teeth portions 31b which are adjacent to each other, that is, which are arranged side by side. The number of the plural slots 32 is the same as the number of the plural teeth portions 31b.

The rotor 2 includes a rotor core 21 including a cylindrical shape and formed of plural magnetic steel sheets laminated or stacked each other. The rotor 2 includes the plural permanent magnets 22 buried in the rotor core 21. The rotor core 21 is supported by a shaft member and is configured in such a manner that the rotor 2 is rotatable in the circumferential direction X relative to the stator 3. The permanent magnets 22 are formed of, for example, rare-earth magnet, and a north pole (N pole) and a south pole (S pole) are arranged alternately with each other in the circumferential direction X. An outer circumferential surface of the plural permanent magnets 22 may be exposed from the rotor core 21.

The motor M of the embodiment is configured of fractional slot in which the denominator of an irreducible fraction (which will be hereinafter referred to also as the number of slots per pole per phase) obtained by dividing the number of slots 32 of the stator 3 by the number of phases (three phases in the embodiment) and by the number of the magnetic poles of the rotor 2 is equal to or greater than four. The motor M is configured by distributed winding in which the number of slots per pole per phase is greater than one. In other words, when the number of slots per pole per phase is expressed in a mixed fraction, the integer portion of the mixed fraction is equal to or greater than one. For example, the number of slots per pole per phase is 5/4 on the motor M including eight poles and thirty slots, and the number of slots per pole per phase is 7/4 on the motor M including eight poles and forty-two slots.

For example, the winding to be wound on the plural slots 32 is configured of the conductive wire which corresponds to copper wire coated with insulation layer. For the winding, round wire including a round cross section and/or various conducting wire including a polygonal cross section are used. A winding method of the winding onto the slots 32 is the distributed winding, and double-layer winding is generally applied.

As an example of the method of winding the wire onto the slots 32, a unit coil 11 of the double-layer winding of the distributed winding is illustrated in FIG. 2. The unit coil 11 is usually configured of the winding wound for plural times, however, the unit coil 11 is presented as a line segment for the purpose of convenience. The unit coil 11 includes a pair of coil sides 11a and 11a along the axial direction Z, and a pair of coil ends 11b and 11b along the circumferential direction X. The coil sides 11a and 11a correspond to portions accommodated in the slots 32. The coil ends 11b and 11b are arranged on axial end surfaces of the teeth portion 31b (that is, end surfaces of the teeth portion 31b in the axial direction X), respectively, and are electrically connected to the coil sides 11a and 11a.

As illustrated in FIG. 1, each coil of each phase (a U phase, a V phase and a W phase) includes plural sets of two-layer units 12 (for example, two sets in the drawing). The two-layer unit 12 is configured of the coil sides 11a of two layers of the unit coils 11 formed of two unit coils 11 stacked or layered each other along the radial direction Y in the slot 32. Winding directions of the plural layers of unit coils 11 (for example, four layers in the drawing) are identical to each other. Coil pitches (a distance between the coil sides 11a and 11a that are arranged as the pair, refer to FIG. 2) of the plural layers (for example, four layers in the drawing) of unit coils 11 are identical to each other.

The coil pitch is an integer which is close to the number of slots per pole obtained by dividing the number of the slots 32 of the stator 3 by the number of the magnetic poles of the rotor 2. For example, in a case where the motor M includes eight poles and thirty slots (the number of slots per pole is 3.75), the coil pitch is three slots (fractional pitch winding or short-pitch winding) or four slots (long-pitch winding). In a case where the motor M includes eight poles and forty-two slots (the number of slots per pole is 5.25), the coil pitch is five slots (fractional pitch winding) or six slots (long-pitch winding).

As described above, according to the embodiment, the coil of each phase includes the coil sides 11a of the two layers of the unit coil 11, which serve as one set of two-layer units 12, accommodated in the slot 32 in a manner that the coil sides 11a are stacked for plural sets in the radial direction Y. The coils of the three phases are electrically connected to one another with Y connection. The connection of the coils is not limited, and the coils of the three phases may be electrically connected with delta connection.

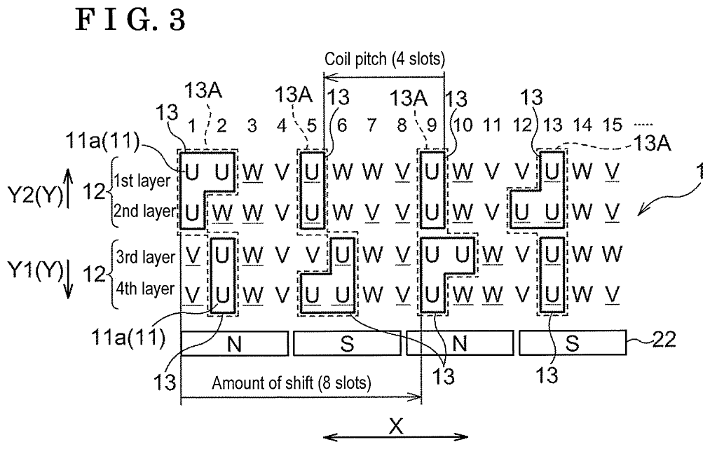

(Phase arrangement in a case where the denominator of the irreducible fraction is an even number) (In a case where the number of the layers of the two-layer units stacked in the radial direction corresponds to a value obtained by dividing the denominator of the irreducible fraction by two) Illustrated in FIG. 3 is a phase arrangement at the motor M including eight poles and thirty slots. In the drawing, the sequential numbers indicated at a top portion of the drawing indicate slot numbers. For example, the slot corresponding to the slot number 1 is the first slot 32. Each of the slots 32 accommodates therein four layers of the coil sides 11a (two sets of the two-layer units 12) which are formed of at least one of the phases (the U phase, the V phase and the W phase). The coil of the U phase, the coil of the V phase and the coil of the W phase are arranged in the mentioned order while phase is shifted relative to each other by 120 degrees of an electrical angle. Except for the shift of the phase, each of the phases (the U phase, the V phase and the W phase) includes an identical phase arrangement, and thus an explanation will be made for the coil of the U phase as a representative example. In the drawings, the notation or indication of “U” and the notation of “U” (the underlined character U) indicate that the directions of the electric currents thereof are opposite to each other. The same notation such as “U” and the notation of “U” means that directions of the electric currents of the coil sides 11a are same as each other. The same notation such as “U” (the underlined character U) and “U” (the underlined character U) means that directions of the electric currents of the coil sides 11a are same as each other. In the radial direction Y, the first layer, the second layer, the third layer and the fourth layer are arranged in the mentioned order from the coil side 11a arranged at the outermost side in the radially outward direction Y2 towards the coil side 11a arranged at the innermost side in the inward direction Y1.

In the embodiment, in the two-layer unit 12, in each pole (that is, in one of the N pole or one of the S poles), a group of the coil sides 11a which are accommodated in one of the slots 32 or in the plural slots 32 adjacent to each other and which include the same phase and the same direction of electric current is defined as a phase belt 13. “A group of the coil sides 11a which are accommodated in one of the slots 32 or in the plural slots 32 adjacent to each other and which include the same phase and the same direction of electric current in each pole” is synonymous with a group of the coil sides 11a of which the phase is the same as each other, of which the direction of electric current is the same as each other, and which are accommodated in one of the slots 32 or in the plural slots 32 continuously adjacent to each other in the circumferential direction X.

In the example illustrated in FIG. 3, in the two-layer unit 12 formed of the first layer and the second layer, the number of the coil sides 11a of the U phase which include the same direction of electric current and which are accommodated in the first and the second slots 32 facing the N pole is three. The phase belt 13 is formed of the two coil sides 11a of the first layer and the one coil side 11a of the second layer, that is, the three coil sides 11a in total. Similarly, the phase belt 13 in the fifth slot 32 facing the S pole is formed of the coil side 11a of the first layer and the coil side 11a of the second layer, that is, the two coil sides 11a in total. The phase belt 13 in the ninth slot 32 facing the N pole is formed of the coil side 11a of the first layer and the coil side 11a of the second layer, that is, the two coil sides 11a in total. The phase belt 13 in the twelfth and the thirteenth slots 32 facing the S pole is formed of the coil side 11a of the first layer and the two coil sides 11a of the second layer, that is, the three coil sides 11a in total.

The numbers of the coil side 11a of the first layer are different between the phase belt 13 in the first and second slots 32 and the phase belt 13 in the twelfth and thirteenth slots 32. Also, the numbers of the coil side 11a of the second layer are different between the phase belt 13 in the first and second slots 32 and the phase belt 13 in the twelfth and thirteenth slots 32. Here, even though the phase belts 13 include the same number of the coil sides 11a to each other, in a case where the arrangements of the coil sides 11a in the first layer and the second layer are different from each other, the difference is indicated by the presence or absence of an asterisk character provided at the numeric character indicating the number of the coil sides 11a, as in 3 and 3*. That is, in the two-layer unit 12 formed of the first layer and the second layer, the numbers of the coil sides 11a of the phase belts 13 are 3, 2, 2, 3* in the mentioned order which correspond to one cycle (four poles), and the two cycles (eight poles) are repeated.

Because the number of the slots per pole per phase is 5/4 in a case of the eight poles and thirty slots, the one cycle is configured by the same number of poles (four poles) as the value of the denominator (four) and the number of the coil sides 11a of the coil of each phase in one layer in one cycle is the value of the numerator (five). That is, the number of the coil sides 11a of each phase forming one cycle in the two-layer unit 12 corresponds to a value (ten) obtained by doubling the numerator. The number of the ten coil sides 11a is divided into four and the ten coil sides 11a are arranged at the four poles, and thus the one cycle is configured by 3, 2, 2, 3* of the coil sides 11a.

As described above, at the motor M of the double-layer winding that is formed of eight poles and thirty slots, the numbers of the coil sides 11a of the phase belts 13 are 3, 2, 2, 3* in the stated order and correspond to one cycle (four poles), and two of the cycles are repeated (eight poles).

In a case where the motor M includes the fractional slot configuration such as eight poles and thirty slots, ratio of magnitude of magnetomotive force of the two-layer unit 12 changes or varies in 3:2:2:3, and thus a magnetic attractive force acting between the rotor 2 and the stator 3 becomes uneven or non-uniform in the circumferential direction X of the rotor 2. As a result, in a case where an electric vehicle and/or a hybrid vehicle are driven by the motor M, an excitation force of a space deformation mode including a low-order which is lower compared to the number of poles (eight poles) of the rotor 2 occurs more easily, and thus the noise and vibration increase in a range of low number of revolutions where a natural frequency of the stator 3 that corresponds to the space deformation mode including a low-order and a frequency of the exciting force of the space deformation mode including the low-order match with each other. That is, a vehicle speed range in which the noise and vibration increase becomes lower. The vehicle speed range in which the noise and vibration increases comes close to a range of low vehicle speed in which the vehicle is often driven. This increases frequency of opportunities in which the noise and vibration become large.

In the embodiment, therefore, as illustrated in FIG. 3, a mixed coil 1 is configured of the phase belts 13 arranged in such a manner of 3, 2, 2, 3* in the circumferential direction X in the first and second layers, and the phase belts 13 which are arranged in such a manner of 2, 3*, 3, 2 in the circumferential direction X in the third and fourth layers and which are shifted or offset in the circumferential direction X by a predetermined number of slots (for example, eight slots) relative to the phase belts 13 in the first and second layers. In the mixed coil 1, a group of the coil sides 11a which are accommodated in the plural slots 32 continuously adjacent to each other in the circumferential direction X and which include the same phase and the same direction of electric current is referred to as a mixed phase belt 13A. Plural of the mixed phase belts 13A are arranged in such a manner of 5, 5*, 5′, 5′*, and the number of the coil sides 11a is identical in each pole. Here, the presence or absence of ′ (an apostrophe character) as in “5” (a numeric character without the apostrophe character) and “5′” (a numeric character with the apostrophe character) indicates a difference of the arrangement of the phase, and the same applies hereunder.

That is, the plural phase belts 13 are formed in a mixed manner such that the ratio of size or magnitude of the magnetomotive force generated by the plural coil sides 11a forming the plural mixed phase belts 13A is even or substantially even in the respective poles. As a consequence, the magnetomotive force occurring upon electrification of the coil is more evenly generated, and it is less likely that the exciting force of the spatial deformation mode including the low-order which is lower compared to the number of poles of the rotor 2 occurs. Accordingly, the noise and vibration in the low-rotation range due to the low-order space deformation mode of the stator 3 that is attributed to the phase arrangement of the stator winding can be reduced. As a result, the vehicle speed range where the noise and vibration increase can be shifted from the range of low vehicle speed at which the vehicle is frequently driven to a range of high vehicle speed or to a range equal to or higher than the maximum vehicle speed, in each of which the vehicle is driven less frequently. Consequently, the frequency of the opportunities in which the noise and vibration increase can be reduced.

As described above, in the embodiment, the denominator of the irreducible fraction (5/4) is an even number. The number of layers of one two-layer unit 12 formed of the phase belt 13 (a first phase belt 13) in the first and second layers and other two-layer unit 12 formed of the phase belt 13 (a second phase belt 13) in the third and fourth layers corresponds to the value (two layers) obtained by dividing the denominator by two. That is, the number of layers of the plural phase belts 13 stacked in the radial direction Y is the value obtained by dividing the denominator of the irreducible fraction by two. Accordingly, the number of layers that are accommodated in each of the slots 32 in the mixed manner can be reduced as much as possible. As a result, the noise and vibration can be reduced without complicating the distributed winding configuration of the winding to each slot 32.

In the mixed coil 1 in which the number of layers of the phase belts 13 stacked in the radial direction Y corresponds to the value obtained by dividing the denominator of the irreducible fraction by two, an amount of shift or an amount of offset (a predetermined number of slots) between the phase belt 13 (the first phase belt 13) formed of the first and second layers and the phase belt 13 (the second phase belt 13) formed of the third and fourth layers is specified as follows, such that the mixed phase belt 13A includes the same number of the coil sides 11a in each pole.

In the embodiment, the amount of shift of the first phase belt 13 and the second phase belt 13 relative to each other is defined or specified according to any of the following definitions (1) to (3); (1) An integer value obtained by doubling a nearest or closest integer that is nearest or closest to the number of slots per pole, (2) A value obtained by adding one to the integer value obtained by doubling the closest integer that is closest to the number of slots per pole in a case where a value obtained by subtracting the closest integer from the number of slots per pole is positive, and (3) A value obtained by subtracting one from the integer value obtained by doubling the closest integer that is closest to the number of slots per pole in a case where the value obtained by subtracting the closest integer from the number of slots per pole is negative.

Next, verification will be made that an extent or spread of the width of the coil sides 11a, in the circumferential direction X, which form the mixed phase belt 13A can be minimized by following the above-described definition. This is because, by minimizing the extent of the width, in the circumferential direction X, of the coil sides 11a forming the mixed phase belt 13A, an inconvenience that the magnetomotive forces of the respective mixed phase belts 13A arranged adjacent to each other in the circumferential direction X exert influences on each other can be prevented. Thus, decrease in torque can be restricted.

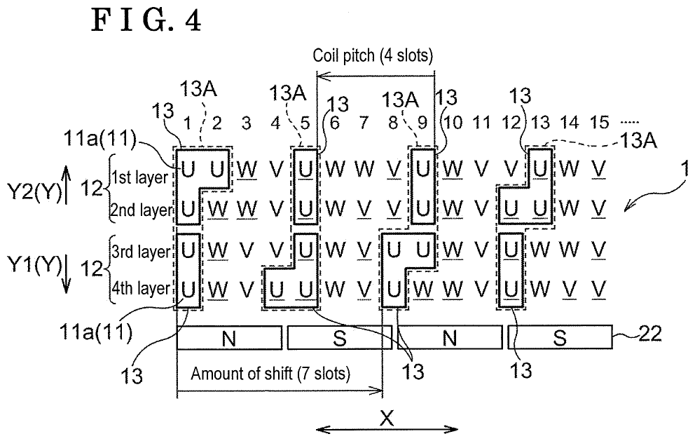

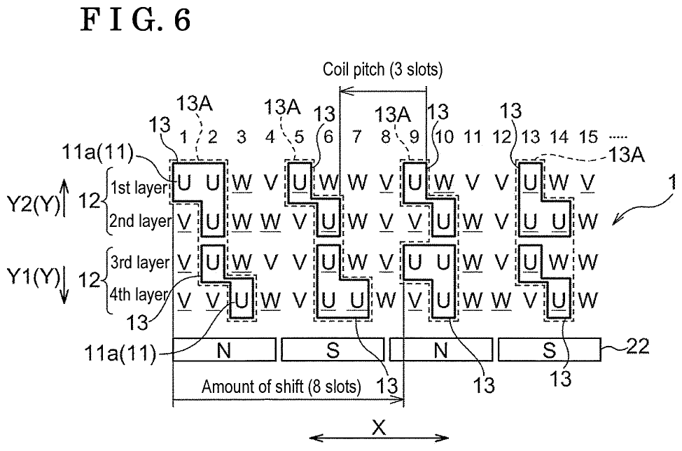

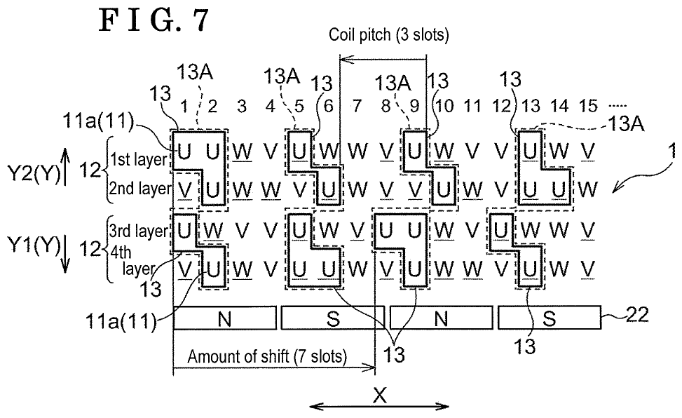

As described above, the motor M with eight poles and thirty slots includes the number of slots per pole per phase of 5/4 (1.25). The value (3.75) obtained by multiplying the number of slots per pole per phase by the number of phases (three phases) corresponds to the number of slots per pole. Accordingly, the closest integer closest to the number of slots per pole is four. Thus, in a case of the definition (1) described above, the amount of shift of the first phase belt 13 and the second phase belt 13 relative to each other is eight slots (refer to FIGS. 3 and 6). In a case of the definition (2) and (3) described above, the subtracted value (−0.25) obtained by subtracting the closest integer that is closest to the number of slots per pole from the number of slots per pole is negative. Thus, the definition (3) is applied, and accordingly the amount of shift of the of the first phase belt 13 and the second phase belt 13 relative to each other is seven slots (refer to FIGS. 4 and 7).

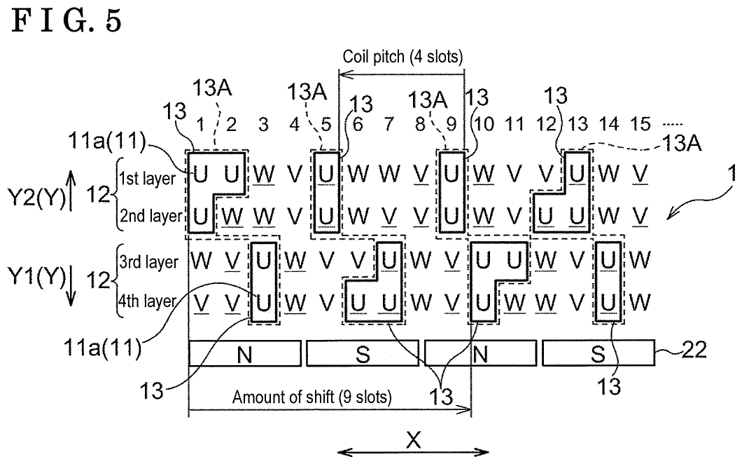

Each of FIGS. 3 to 5 illustrates an example of the long-pitch winding with the coil pitch of four slots at the motor M including eight poles and thirty slots (the number of slots per pole is 3.75). An example of the definition (1) is illustrated in FIG. 3 (5, 5*, 5′, 5′*) in which the width, in the circumferential direction X, of the coil sides 11a forming each mixed phase belt 13A is two slots at all the mixed phase belts 13A. An example of the definition (3) is illustrated in FIG. 4 (5′, 5′*, 5, 5*) in which the width, in the circumferential direction X, of the coil sides 11a forming each mixed phase belt 13A is two slots at all the mixed phase belts 13A. On the other hand, FIG. 5 illustrates an example that deviates from the above-described definitions. In the example of FIG. 5, in a case where the amount of shift of the first phase belt 13 and the second phase belt 13 relative to each other is nine slots, the width, in the circumferential direction X, of the coil sides 11a forming each mixed phase belt 13A is three slots at all the mixed phase belts 13A. That is, by complying with the above-described definitions, the extent of the width of the coil sides 11a, in the circumferential direction X, which form the mixed phase belt 13A can be minimized.

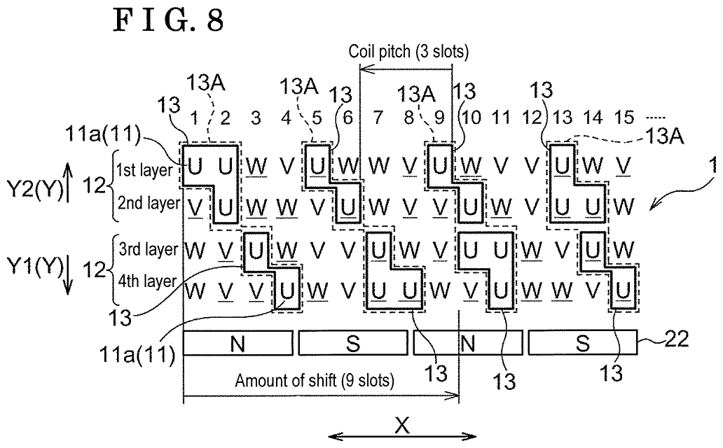

Each of FIGS. 6 to 8 illustrates an example of the short-pitch winding with the coil pitch of three slots at the motor M including eight poles and thirty slots (the number of slots per pole is 3.75). An example of the definition (1) is illustrated in FIG. 6 (5″, 5″*, 5, 5*) in which the width, in the circumferential direction X, of the coil sides 11a forming the mixed phase belt 13A is a maximum of three slots. An example of the definition (3) is illustrated in FIG. 7 (5, 5*, 5″, 5″*) in which the width, in the circumferential direction X, of the coil sides 11a forming the mixed phase belt 13A is a maximum of three slots. On the other hand, FIG. 8 illustrates an example that deviates from the above-described definitions. In the example of FIG. 8, in a case where the amount of shift of the first phase belt 13 and the second phase belt 13 relative to each other is nine slots, the width, in the circumferential direction X, of the coil sides 11a forming the mixed phase belt 13A is a maximum of four slots. That is, by complying with the above-described definitions, the circumferential extent or spread of the width of the coil sides 11a, in the circumferential direction X, which make up the mixed phase belt 13A can be minimized.

In a case of the motor M including eight poles and forty-two slots, the number of slots per pole per phase is 7/4 (1.75). The value (5.25) obtained by multiplying the number of slots per pole per phase by the number of phases (three phases) corresponds to the number of slots per pole. Accordingly, the closest integer closest to the number of slots per pole is five. Thus, in a case of the definition (1) described above, the amount of shift of the of the first phase belt 13 and the second phase belt 13 relative to each other is ten slots. In a case of the definition (2) or (3) described above, the subtracted value (0.25) obtained by subtracting the closest integer that is closest to the number of slots per pole from the number of slots per pole is positive. Thus, the definition (2) is applied, and accordingly the amount of shift of the of the first phase belt 13 and the second phase belt 13 relative to each other is eleven slots.

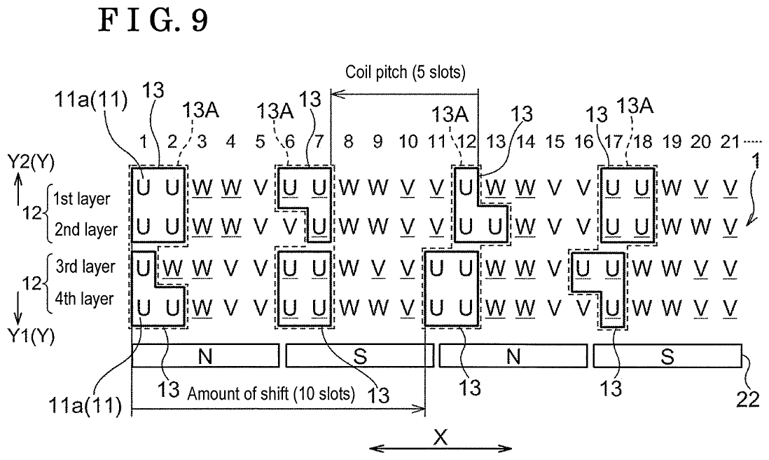

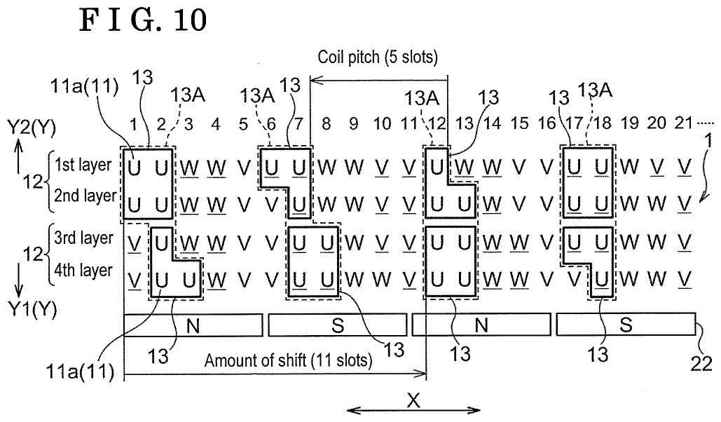

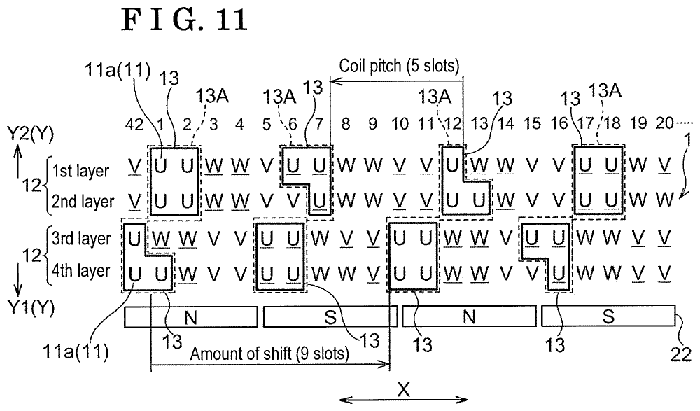

Each of FIGS. 9 to 11 illustrates an example of the short-pitch winding with the coil pitch of five slots at the motor M including eight poles and forty-two slots (the number of slots per pole is 5.25). An example of the definition (1) is illustrated in FIG. 9 (7, 7*, 7′, 7′*) in which the width, in the circumferential direction X, of the coil sides 11a forming the mixed phase belt 13A is a maximum of three slots. An example of the definition (2) is illustrated in FIG. 10 (7′, 7′*, 7, 7*) in which the width, in the circumferential direction X, of the coil sides 11a forming the mixed phase belt 13A is a maximum of three slots. On the other hand, FIG. 11 illustrates an example that deviates from the above-described definitions. In the example of FIG. 11, in a case where the amount of shift of the first phase belt 13 and the second phase belt 13 relative to each other is nine slots, the width, in the circumferential direction X, of the coil sides 11a forming the mixed phase belt 13A is a maximum of four slots. That is, by complying with the above-described definitions, the extent or spread of the width of the coil sides 11a, in the circumferential direction X, which configure the mixed phase belt 13A can be minimized.

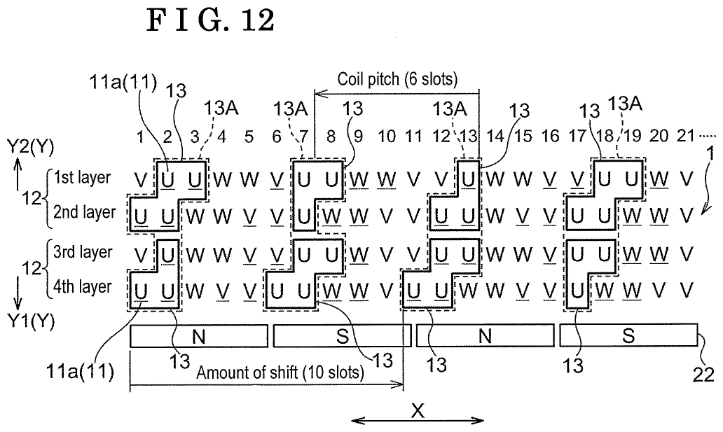

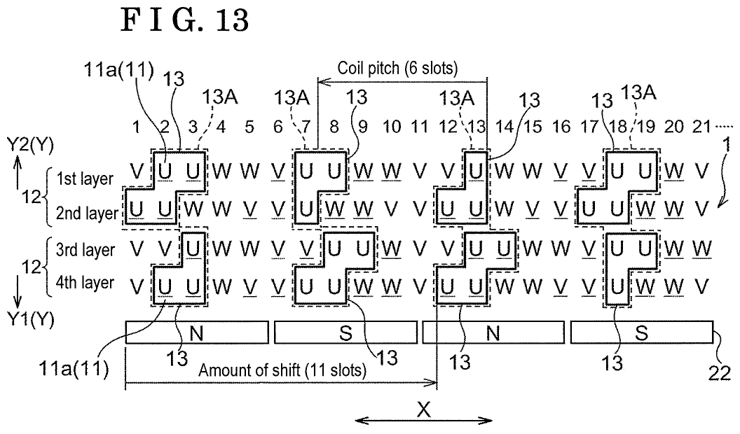

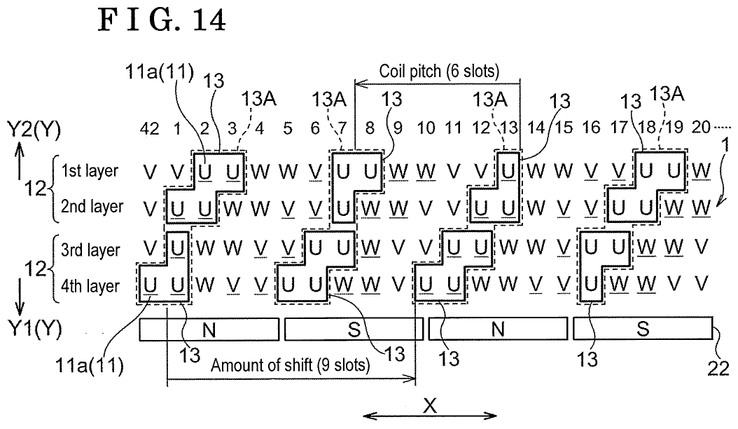

Each of FIGS. 12 to 14 illustrates an example of the long-pitch winding with the coil pitch of six slots at the motor M including eight poles and forty-two slots (the number of slots per pole is 5.25). An example of the definition (1) is illustrated in FIG. 12 (7′, 7′*, 7″, 7″*) in which each of the width, in the circumferential direction X, of the coil sides 11a forming the mixed phase belt 13A is three slots at all the mixed phase belts 13A. An example of the definition (2) is illustrated in FIG. 13 (7″, 7″*, 7′, 7′*) in which the width, in the circumferential direction X, of the coil sides 11a forming the mixed phase belt 13A is three slots at all the mixed phase belts 13A. On the other hand, FIG. 14 illustrates an example that deviates from the above-described definitions. In the example of FIG. 14, in a case where the amount of shift of the first phase belt 13 and the second phase belt 13 relative to each other is nine slots, the width, in the circumferential direction X, of the coil sides 11a forming the mixed phase belts 13A is four slots at all the mixed phase belts 13A. That is, when the above-described definitions are followed, the extent or spread of the width, in the circumferential direction X, of the coil sides 11a which form the mixed phase belt 13A can be minimized.

In a case of the motor M including eight poles and twenty-seven slots, the number of slots per pole per phase is 9/8. Accordingly, one cycle includes the same number of poles (eight poles) as the value (8) of the denominator. The number of the coil sides 11a of the winding of each phase in one layer in one cycle corresponds to the value (9) of the numerator. That is, the number of the coil sides 11a of each phase forming one cycle in the two-layer unit 12 corresponds to a value (18) obtained by doubling the numerator. The number of the coil sides 11a of the first phase belt 13 corresponds to 3, 3*, 2, 2*, 2, 2, 2*, 2, that is, eighteen in total.

In a case where the number of layers of the phase belts 13 stacked in the radial direction Y corresponds to a value obtained by dividing the denominator of the irreducible fraction by two, the number of layers of the phase belts 13 is four. Because the number of slots per pole is 3.375 in a case of the eight poles and twenty-seven slots, the amount of shift between the first phase belt 13 and the second phase belt 13 relative to each other corresponds to six slots in a case of the definition (1) where the integer value obtained by doubling the closest integer (3) that is closest to the number of slots per pole. That is, the number of the coils sides 11a of the second phase belt 13 corresponds to 2*, 2, 3, 3*, 2, 2*, 2, 2. On the other hand, the number of layers of the phase belts 13 stacked on each other needs to be four, and therefore another set of a third phase belt 13 and a fourth phase belt 13 is formed to configure the mixed coil 1. When the third phase belt 13 is shifted or offset relative to the second phase belt 13 by six slots, the fourth phase belt 13 is shifted or offset relative to the third phase belt 13 by six slots, the number of the coils sides 11a of the third phase belt 13 corresponds to 2, 2, 2*, 2, 3, 3*, 2, 2* and the number of the coil sides 11a of the fourth phase belt 13 corresponds to 2, 2*, 2, 2, 2*, 2, 3, 3*. The number of the coil sides 11a of the mixed phase belt 13A in which the coil sides 11a are arranged in the radial direction Y of the slots 32 corresponds to 9′, 9′*, 9, 9′, 9′*, 9, 9′, 9′*. As a result, the plural phase belts 13 are configured in the mixed manner so that the ratio of magnitude of magnetomotive force generated by the plural coil sides 11a forming the plural mixed phase belts 13A is equal in the respective poles.

(In a case where the number of the layers of the two-layer units stacked in the radial direction corresponds to the denominator of the irreducible fraction) For example, at the motor M including eight poles and thirty slots, four of the two-layer units 12 may be stacked or layered in the radial direction Y of the slots 32 (from the first phase belt 13 to the fourth phase belt 13) so as to form the eight layers. That is, the number of layers (four) of the phase belts 13 stacked in the radial direction Y may be the denominator of the irreducible fraction (5/4). In this case, it is ideal that the amount of shift or offset (the predetermined number of slots) among the phase belts 13 adjacent to one another in the radial direction Y is the integer (four slots) that is closest to the number of slots per pole (3.75). That is, the coil sides 11a of the first phase belt 13 correspond to 3, 2, 2, 3*, the coil sides 11a of the second phase belt 13 correspond to 3*, 3, 2, 2, and the coil sides 11a of the third phase belt 13 correspond to 2, 3*, 3, 2, and the coil sides 11a of the fourth phase belt 13 correspond to 2, 2, 3*, 3. Thus, the mixed phase belts 13A arranged as 10, 10′, 10*, 10″ in the circumferential direction X are formed. As a result, the ratio of magnitude or strength of the magnetomotive forces generated by the coil sides 11a in the same phase is even in the respective poles, and the coil sides 11a are more evenly arranged, and thus the noise and vibration attributed to the phase arrangement of the stator winding are more reduced.

A first mixed phase belt 13A arranged in the circumferential direction X with 5, 5*, 5′, 5′* may be formed in the first to fourth layers and a second mixed phase belt 13A arranged in the circumferential direction X with 5′*, 5, 5*, 5′ may be formed in the fifth to eighth layers. In this case, the mixed phase belt 13A configured of the fifth to eighth layers is formed to be shifted or offset by the predetermined number of slots (fourth slots) relative to the mixed phase belt 13A configured of the first to fourth layers.

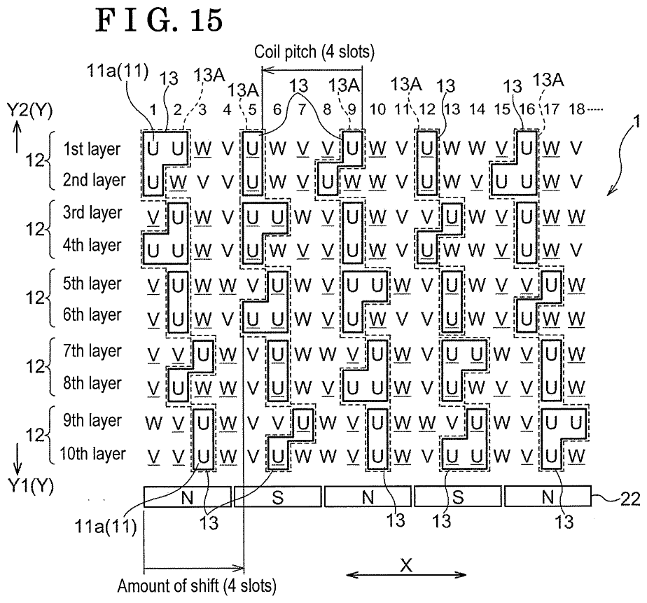

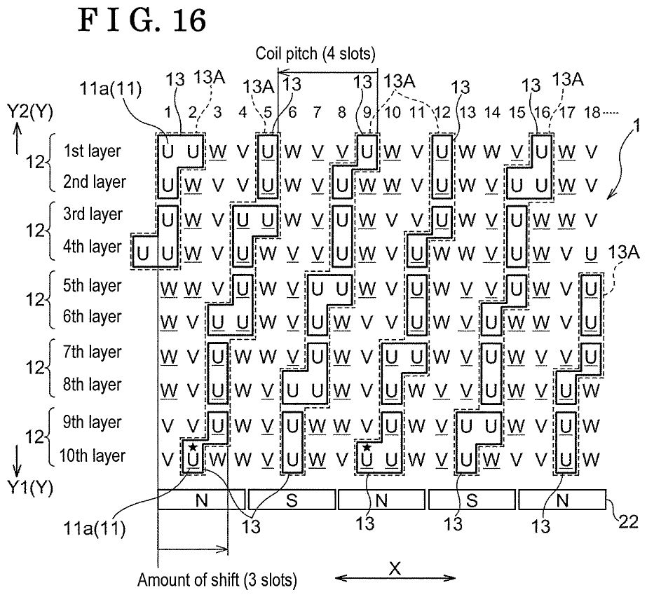

(Phase arrangement in a case where the denominator of the irreducible fraction is an odd number) Each of FIGS. 15 and 16 illustrates an example of the long-pitch winding with the coil pitch of four slots at the motor M which includes ten poles and thirty-six slots and at which the denominator of the irreducible fraction is an odd number (the number of slots per pole per phase is 6/5, the number of slots per pole is 3.6). At the motor M, one cycle includes is formed of the same number of poles (five poles) same as the value (five) of the denominator, and the number of the coil sides 11a of the winding of each phase in one layer in one cycle corresponds to the value (six) of the numerator. That is, in the two-layer unit 12, the number of the coil sides 11a per phase forming the one cycle corresponds to the value (twelve) obtained by doubling the numerator, and the number of the coil sides 11a of the first phase belt 13 in the first and second layers corresponds to 3, 2, 2*, 2, 3*, that is, twelve in total.

Similarly to the case in which the number of layers of the phase belts 13 stacked in the radial direction Y corresponds to the denominator of the irreducible fraction, in the present embodiment, it is ideal that the amount of shift (the predetermined number of slots) of the phase belts 13 adjacent to each other in the radial direction Y relative to each other is the closest integer (four) that is closest to the number (3.6) of slots per pole. That is, the amount of shift of the phase belts 13 stacked in the radial direction Y relative to each other is four slots. As a result, as illustrated in FIG. 15, the coil sides 11a of the second phase belts 13 in the third and fourth layers correspond to 3*, 3, 2, 2*, 2, the coil sides 11a of the third phase belts 13 in the fifth and sixth layers correspond to 2, 3*, 3, 2, 2*, the coil sides 11a of the fourth phase belt 13 in the seventh and eighths layers correspond to 2*, 2, 3*, 3, 2, and the coil sides 11a of a fifth phase belt 13 in the ninth and tenth layers correspond to 2, 2*, 2, 3*, 3. Thus, the circumferential width in the circumferential direction X, of the coil sides 11a forming the mixed phase belt 13A corresponds to three slots and four slots in a mixed manner, and the mixed phase belts 13A arranged in 12, 12, 12, 12, 12, in the circumferential direction X are formed. As a result, the arrangement of the coil sides 11a of the same phase become uniform or more uniform compared to a conventional case, and the ratio of magnitude of magnetomotive forces of the coil sides 11a of the same phase becomes uniform, and thus the noise and vibration attributed to the phase arrangement of the stator winding can be further reduced.

On the other hand, FIG. 16 illustrates an example that deviates from the above-described definitions. In the example of FIG. 16, in a case where the amount of shift of the phase belts 13 relative to one another is three slots, the width, in the circumferential direction X, of the coil sides 11a forming the mixed phase belt 13A is four slots in all of the mixed phase belts 13A. In this case, the coil sides 11a of which the directions of current are opposite to each other are placed in a mixed manner in each of the second slot and the ninth slot both of which is provided with the star mark, thereby deteriorating performance of the motor M. Also in a case where the amount of shift of the phase belts 13 relative to one another is five slots, the coil sides 11a including the opposite directions of current to each other exist in the mixed manner, thereby deteriorating the performance of the motor M.

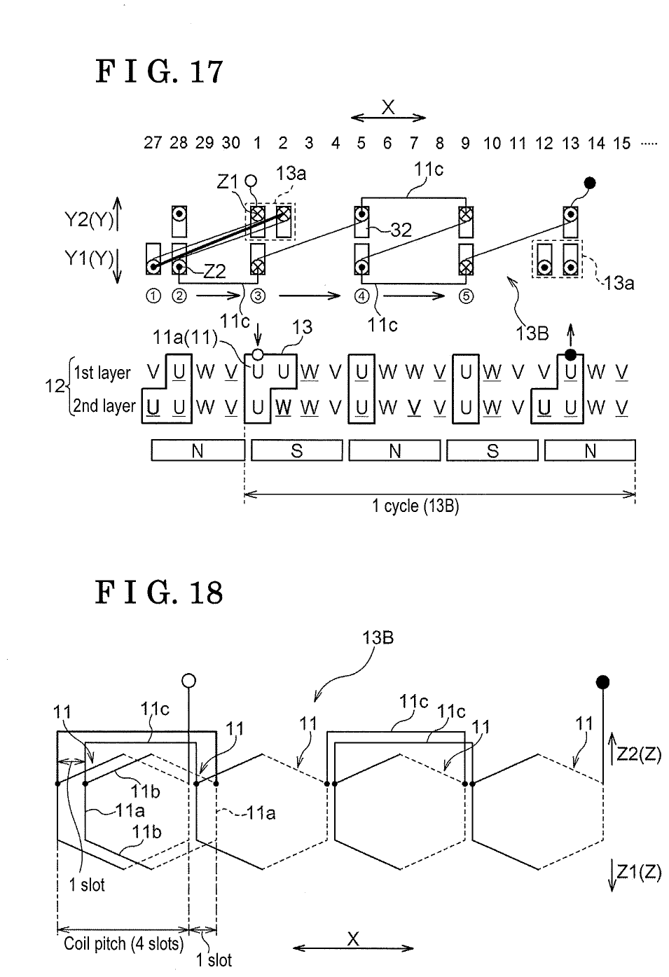

(Winding configuration) (Winding configuration in the two-layer unit 12) A winding configuration in the two-layer unit 12 formed of the coil sides 11a of the two layers of unit coils 11 stacked in the slot 32 along the radial direction Y will be described with reference to FIGS. 17 to 22.

FIG. 17 illustrates a plan view (viewed in the axial rear direction Z1) related to a winding structure of the unit coil 11 at the motor M including eight poles and thirty slots. FIG. 18 illustrates a lateral view (viewed in the radially outward direction Y2) related to the winding structure of the unit coil 11 at the motor M including the eight poles and thirty slots. As described above, because the number of slots per pole per phase of the motor M provided with the eight poles and thirty slots is 5/4, one cycle is formed the same number of poles (four poles) as the value (four) of the denominator, and the number of the coil sides 11a of the winding of each phase in the two layers in the one cycle corresponds to a value (ten) obtained by doubling the value (five) of the numerator. The plural (four) phase belts 13 of the one cycle form a phase belt group 13B by a combination of the unit coils 11 where single winding is continuously wound at the slots 32. Two of the phase belt groups 13B are formed in the two-layer unit 12 of the eight poles and thirty slots, and the two phase belt groups 13B are electrically connected to each other with conductive wire (connecting wire) in series or in parallel.

The sequential numbers indicated at a top portion of the drawings indicate the slot numbers. For example, the slot corresponding to the slot number 1 is the first slot 32. Out of the phase belts 13, the phase belt 13 placed in the first and second slots 32 in the first layer is defined as a layer phase belt 13a in which the plural slots 32 in the same layer are adjacent to each other, and also the phase belt 13 placed in the twelfth and thirteenth slots 32 in the second layer is defined as the layer phase belt 13a in which the plural slots 32 in the same layer are adjacent to each other.

In the example of FIG. 17, a winding start (indicated with a white circle) of the winding is provided at a slot bottom-side of the first slot 32 in the first layer and a winding end (indicated with a black circle) of the winding is provided at a slot bottom-side of the thirteenth slot 32 in the first layer. The first slot 32 in the first layer and the twenty-seventh slot 32 in the second layer make up the unit coil 11, thereby forming the long-pitch winding with the coil pitch of four slots. The circled numeric characters appearing between the upper illustration and the lower illustration in FIG. 17 indicate the winding order of each unit coil 11, and each arrow appearing between the upper illustration and the lower illustration indicates a development direction or progress direction of the unit coil 11 from the winding start of the winding to the winding end of the winding (which will be hereinafter referred to as development direction). At the unit coils 11 illustrated in FIG. 18, the dashed lines indicate the coil sides 11a and the coil ends 11b which are arranged at a Y2 side in the radially outward direction Y2 (that is, at the slot bottom-side) and the solid lines indicate the coil sides 11a and the coil ends 11b which are arranged at a Y1 side in the radially inward direction Y1 (that is, at a slot opening-side).

As illustrated in FIGS. 17 and 18, the winding starts from the first slot 32 in the first layer in the axial rear direction Z1. The winding is wound between the first slot 32 in the first layer and the twenty-seventh slot 32 in the second layer to form the unit coil 11. Next, the winding pulled out in the axial front direction Z2 from the twenty-seventh slot 32 in the second layer is utilized, as is, as a unit coil connecting wire (indicated with the thick line) which connects the unit coils to each other, and thus is connected to the second slot 32 in the first layer. Next, the winding is wound between the second slot 32 in the first layer and the twenty-eighth slot 32 in the second layer to form the unit coil 11

Next, the winding pulled out in the axial front direction Z2 from the twenty-eighth slot 32 in the second layer serves as a pole coil connecting wire 11c and is connected to the first slot 32 in the second layer. Plural unit coils 11 facing a pair of poles (the north pole and the south pole) correspond to pole coils, and the “pole coil connecting wire 11c” is conductive wire connecting the unit coil 11 facing the north pole and the unit coil 11 facing the south pole to each other. Next, the winding is pulled into the first slot 32 in the second layer in the axial rear direction Z1, and the winding is wound between the first slot 32 in the second layer and the fifth slot 32 in the first layer to form the unit coil 11.

Next, the winding pulled out from the fifth slot 32 in the first layer in the axial front direction Z2 serves as the pole coil connecting wire 11c and is connected to the ninth slot 32 in the first layer. Next, the winding is pulled into the ninth slot 32 in the first layer in the axial rear direction Z1, and winding is wound between the ninth slot 32 in the first layer and the fifth slot 32 in the second layer to form the unit coil 11.

Next, the winding in the axial front direction Z2 that is pulled out from the fifth slot 32 in the second layer is connected to the ninth slot 32 in the second layer as the pole coil connecting wire 11c. Next, the winding is pulled into the ninth slot 32 in the second layer in the axial rear direction Z1, and winding is wound between the ninth slot 32 in the second layer and the thirteenth slot 32 in the first layer to form the unit coil 11. Then, the winding is finished at the thirteenth slot 32 in the first layer towards the axial front direction Z2.

As described above, the phase belt group 13B where the five unit coils 11 are formed of the single winding is configured, and ten of the coil sides 11a exist in the phase belt group 13B. The phase belt group 13B serves as one cycle, and the phase belt groups 13B corresponding to two cycles are formed in each phase (the U phase, the V phase and the W phase). In the example of FIG. 17, a winding width of the coil, in the circumferential direction X, of the phase belt group 13B corresponds to a width of the four unit coils 11. The pole coil connecting wire 11c, which connects between the two slots 32 that are in the same layer, is provided at the Y2 side in the radially outward direction Y2 and two of the pole coil connecting wires 11c are provided at the Y1 side in the radially inward direction Y1.

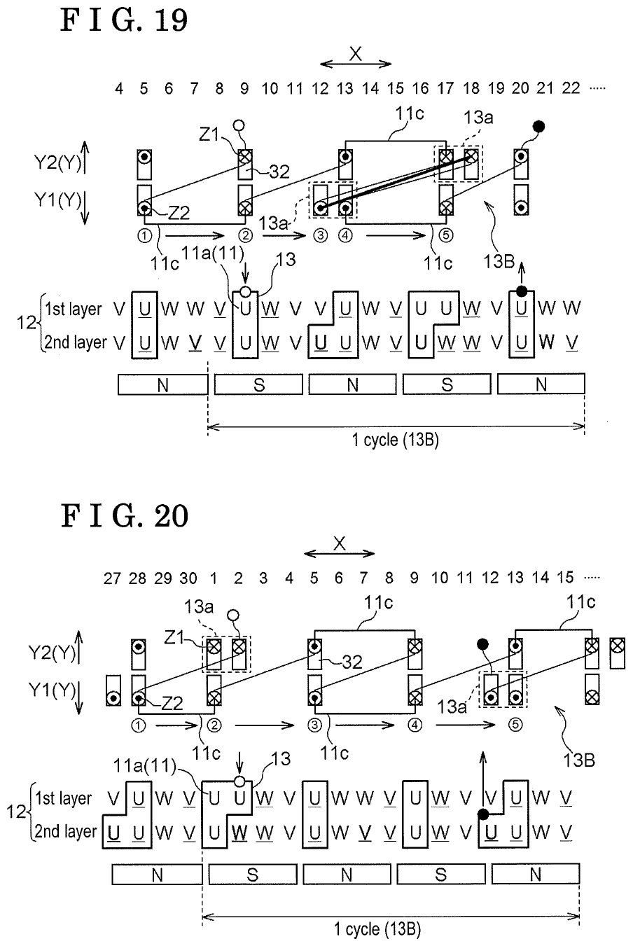

In the example of FIG. 19, a winding start (indicated with a white circle) of the winding is provided at a slot bottom-side of the ninth slot 32 in the first layer and a winding end (indicated with a black circle) of the winding is provided at a slot bottom-side of the twentieth slot 32 in the first layer. Also in the example of FIG. 19, the winding width of the coil, in the circumferential direction X, of the phase belt group 13B corresponds to the width of the four unit coils 11 in a similar manner to the example of FIG. 17. The pole coil connecting wire 11c, which connects between the two slots 32 that are in the same layer, is provided at the Y2 side in the radially outward direction Y2 and two of the pole coil connecting wires 11c are provided at the Y1 side in the radially inward direction Y1.

In the example of FIG. 20, a winding start (indicated with a white circle) of the winding is provided at a slot bottom-side of the second slot 32 in the first layer and a winding end (indicated with a black circle) of the winding is provided at a slot opening-side of the twelfth slot 32 in the second layer. In this case, a winding width of the coil, in the circumferential direction X, of the phase belt group 13B corresponds to a width of the approximately five unit coils 11. With regards to the pole coil connecting wire 11c which connects between the two slots 32 that are in the same layer, two of the pole coil connecting wires 11c are provided at the Y2 side in the radially outward direction Y2 and two of the pole coil connecting wires 11c are provided at the Y1 side in the radially inward direction Y1. That is, in the example of FIG. 20, the width, in the circumferential direction X, of the phase belt group 13B is larger compared to the examples of FIGS. 17 and 19. This invites increase in size of a jig that is used when the phase belt group 13B serving as one unit is assembled from the opening side (the Y1 side) of the slot 32. In addition, in the example of FIG. 20, the number of the pole coil connecting wires 11c each connecting between the two slots 32 that are in the same layer is larger compared to the examples of FIGS. 17 and 19. Thus, a rate of interference with the pole coil connecting wire 11c of other phase increases, thereby making an assembly performance less efficient. In particular, in a case where plural pole coil connecting wires 11c exist at the bottom-side of the slots 32 (at the Y2 side), the interference with the pole coil connecting wire 11c of other phase occurs when the phase belt group 13B serving as one unit is assembled from the opening side of the slots 32, for each phase sequentially. Consequently, the assembly performance is extremely deteriorated.

The phase belt 13 includes the layer phase belt 13a in which the plural slots 32 of the same layer (the first and second slots 32 in the first layer in the example of FIG. 20) are adjacent to each other. In the above-described plural slots 32, the winding start of the winding is not provided at the slot 32 (the second slot 32 in the first layer in the example of FIG. 20) that is positioned between the layer phase belt 13a and the phase belt 13 (the fifth slot 32 in the first layer in the example of FIG. 20) adjacent to the layer phase belt 13a in the development direction of the unit coil 11, according to the embodiment. In other words, in the embodiment, the winding start of the winding is provided at the slot 32 which corresponds to an end of the layer phase belt 13a in a direction opposite to the development direction of the unit coil 11. In a case where the denominator of the number of slots per pole per phase is an even number and the above-described definitions are not followed, the winding start of the winding (the second slot 32 in the first layer in the example of FIG. 20) and the winding end of the winding (the twelfth slot 32 in the second layer in the example of FIG. 20) are arranged in the different layers from each other. This causes a complicated routing of the winding end (for example, insulation treatment needs to be performed because the winding end intersects with the coil end 11b) and size of the coil end 11b increases.

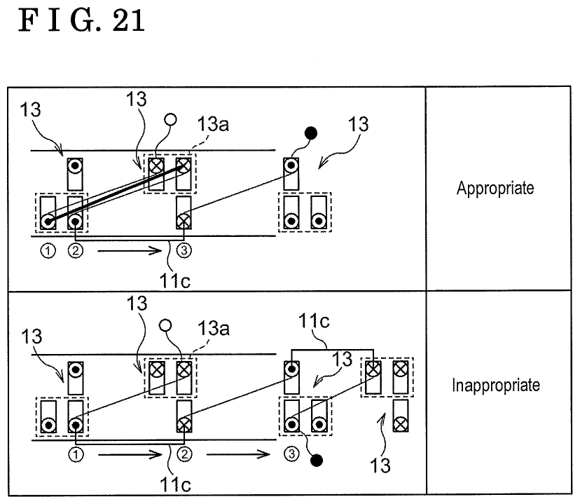

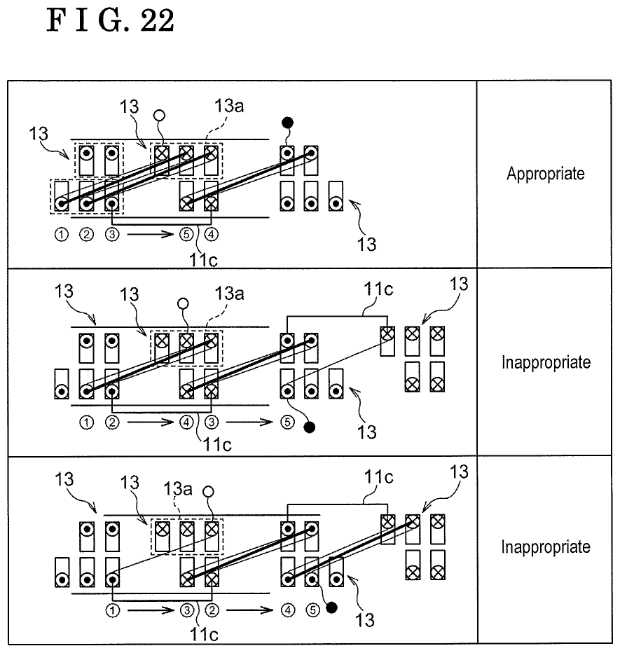

FIG. 21 illustrates the motor M of which the number of slots per pole per phase is 3/2. FIG. 22 illustrates the motor M of which the number of slots per pole per phase is 5/2. FIGS. 21 and 22 show that, in a case where the winding start of the winding is provided at the slot 32 that is included in the above-described plural slots 32 of the same layer and that is positioned between the layer phase belt 13a and the phase belt 13 adjacent to the layer phase belt 13a in the development direction of the unit coil 11 (an inappropriate case), the winding width of the coil increases in the circumferential direction X of the phase belt group 13B and the number of the pole coil connecting wires 11c each connecting between the two slots 32 in the same layer increases, compared to a case where the winding start of the winding is not provided at the above-described slot 32 (an appropriate case). In addition, in a case where the denominator of the number of slots per pole per phase is an even number and if the above-described definitions are not followed, the winding start of the winding and the winding end of the winding are arranged in the different layers from each other.

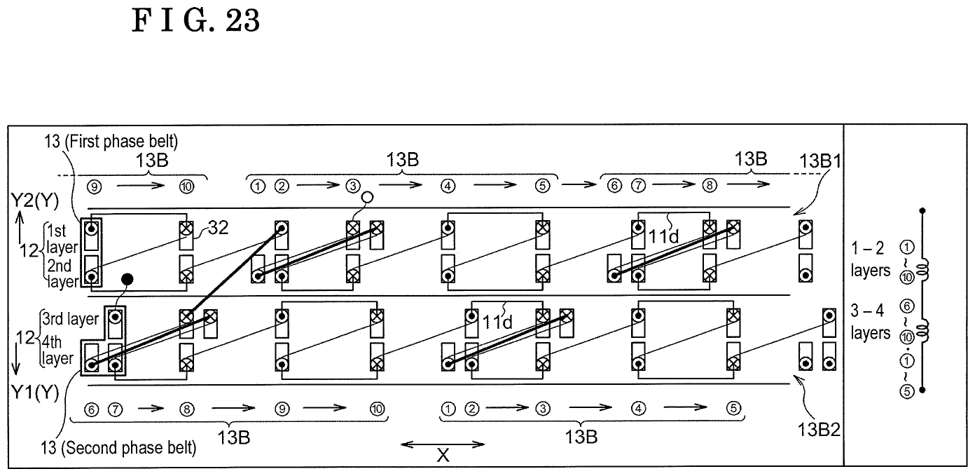

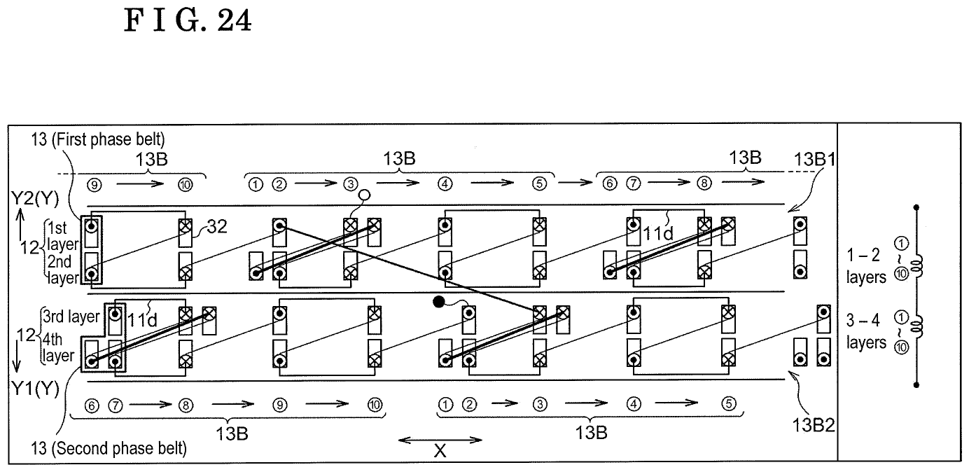

(Winding configuration in series connection) FIGS. 23 and 24 each illustrates an example in which all the phase belts 13 are electrically connected in series in such a manner that one winding start of the winding (each phase terminal in a case of Y-connection) and one winding end of the winding (a neutral point in a case of Y-connection) are provided (refer to the column on the right side in each drawing), at the motor M which includes eight poles and thirty slots and of which the denominator of the irreducible fraction is four. Each of the layers may be divided into n (n is an integer which is equal to or greater than two), all the phase belts 13 of each of the divided layers may be electrically connected in series, and the coils of each of the divided layers may be connected in n-row parallel to each other.

In the embodiment, the phase belt 13 is formed of the first phase belt 13 and the second phase belt 13 which are stacked in the radial direction Y. The first phase belt 13 and the second phase belt 13 are arranged to be shifted or offset to each other by eight slots (the integer value obtained by doubling the closest integer that is closest to the number of slots per pole) in the development direction in a manner similar to the example of FIG. 3. The phase belt group 13B of the first phase belt 13 of which the winding orders are 1 to 5 (the winding order is indicated by the circled numeric characters in the drawings) and the phase belt group 13B of the first phase belt 13 of which the winding orders are 6 to 10 (the winding order is indicated by the circled numeric characters in the drawings) are electrically connected in series to each other with the use of conductive wire (a phase belt group connecting wire 11d, thereby configuring a first serial phase belt 13B1. The phase belt group 13B of the second phase belt 13 of which the winding orders are 1 to 5 and the phase belt group 13B of the second phase belt 13 of which the winding orders are 6 to 10 are electrically connected in series to each other with the use of conductive wire (the phase belt group connecting wire 11d), thereby configuring a second serial phase belt 13B2. In the first phase belt 13 and/or the second phase belt 13, the winding orders 1 to 10 may be configured of single winding.

Then, a winding end (an end portion of the winding whose winding order is 10) of the first serial phase belt 13B1 and a winding start (an end portion of the winding whose winding order is 6 in FIG. 23, an end portion of the winding whose winding order is 1 in FIG. 24) of the second serial phase belt 13B2 are electrically connected in series to each other with the use of conductive wire (connecting wire indicated with the thick line in the drawing). In the example of FIG. 23, a winding end of the first serial phase belt 13B1 and a winding start of the second serial phase belt 13B2 that is shifted from the said winding end towards the direction opposite to the development direction by four slots (by the coil pitch of the long-pitch winding) are electrically connected to each other with the use of conductive wire. On the other hand, in the example of FIG. 24, a winding end of the first serial phase belt 13B1 and a winding start of the second serial phase belt 13B2 that is shifted from the said winding end towards the development direction by eleven slots are electrically connected to each other with the use of conductive wire (connecting wire indicated with the thick line in the drawing). In the example of FIG. 24, the connecting wire between the first serial phase belt 13B1 and the second serial phase belt 13B2 intersects with plural coil ends 11b, and thus the assembly performance is decreased compared to the example of FIG. 23. Moreover, in the example of FIG. 24, the connecting wire needs to be stacked onto the coil ends 11b, thereby increasing size of the motor M. In the embodiment, consequently, at the motor M which includes the serial connection configuration and of which the denominator of the irreducible fraction is four, it is ideal that the winding end of the first serial phase belt 13131 and the winding start of the second serial phase belt 13B2 that is offset from the said winding end of the first serial phase belt 13B1 by the coil pitch towards the side opposite to the development direction are electrically connected to each other with the use of the conductor wire.

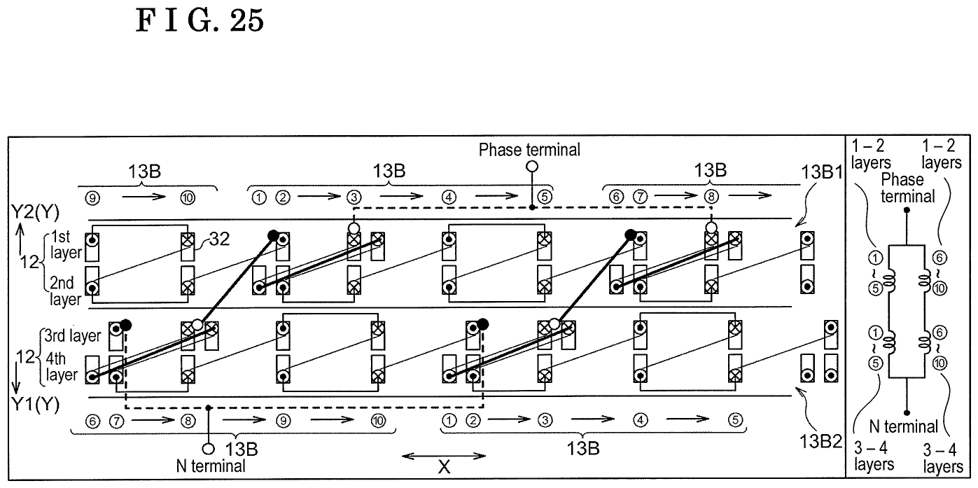

(Winding configuration in parallel connection) In FIGS. 25 to 28, at the motor M including eight poles and thirty slots, the plural phase belts 13 (which are examples of plural outermost phase belts which are in a range in which as many rotor magnetic poles as a number obtained by multiplying the denominator of the irreducible fraction by a predetermined number (one fold) are arranged to be adjacent to each other, and are connected by the five unit coils 11 in the embodiment) of the two-layer unit 12 in the first and second layers are electrically connected in series to each other with the use of conductive wire so as to provide the plural phase belt groups 13B (an example of the first phase belt group, and two of the phase belt groups 13B are provided in the embodiment). The plural phase belt groups 13B are electrically connected in parallel to each other with the use of conductive wire (refer to the column on the right side in each drawing). Similarly, the plural phase belts 13 (which are examples of plural innermost phase belts which are in a range in which as many rotor magnetic poles as a number obtained by multiplying the denominator of the irreducible fraction by a predetermined number (one fold) are arranged to be adjacent to each other, and are connected by the five unit coils 11 in the embodiment) of the two-layer unit 12 in the third and fourth layers are electrically connected in series to each other with the use of conductive wire so as to provide the plural phase belt groups 13B (an example of the second phase belt group, and two of the phase belt groups 13B are provided in the embodiment). The plural phase belt groups 13B are electrically connected in parallel to each other with the use of conductive wire (refer to the column on the right side in each drawing). Then, one of the plural phase belt groups 13B serving as the outermost phase belts and one of the plural phase belt groups 13B serving as the innermost phase belts are electrically connected in series to each other.

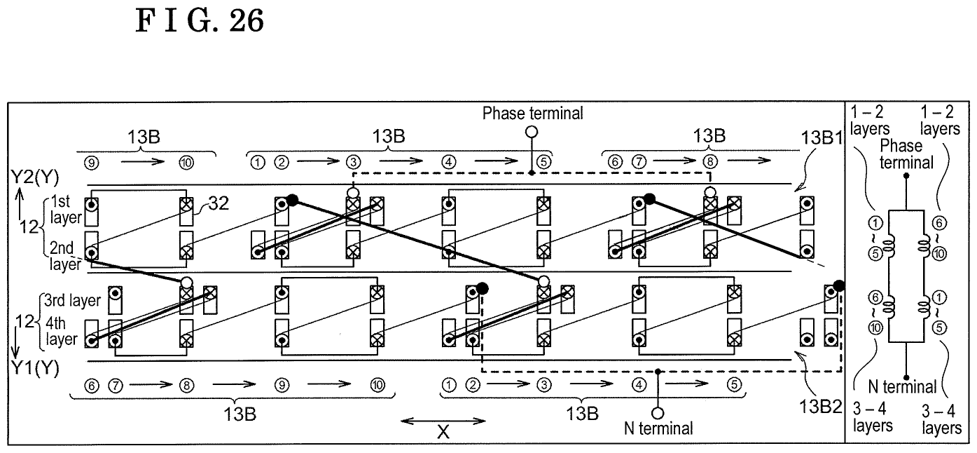

In the examples of FIGS. 25 to 28, the two-layer unit 12 in the first and second layers and the two-layer unit 12 in the third and fourth layers are shifted or offset relative to each other in the development direction by eight slots (the integer value obtained by doubling the closest integer that is closest to the number of slots per pole) in a similar manner to the example of FIG. 3. In the example of FIG. 25, the phase belt group 13B (an example of the first phase belt group), of which the winding orders are 1 to 5 (the circled numeric characters in the drawing), of the two-layer unit 12 in the first and second layers and the phase belt group 13B (an example of the second phase belt group), of which the winding orders are 1 to 5 (the circled numeric characters in the drawing), of the two-layer unit 12 in the third and fourth layers are electrically connected in series to each other with the use of conductive wire (connecting wire which is indicated with the thick solid line in the drawings). And the phase belt group 13B (an example of the first phase belt group), of which the winding orders are 6 to 10 (the circled numeric characters in the drawing), of the two-layer unit 12 in the first and second layers and the phase belt group 13B (an example of the second phase belt group), of which the winding orders are 6 to 10 (the circled numeric characters in the drawing), of the two-layer unit 12 in the third and fourth layers are electrically connected in series to each other with the use of conductive wire (connecting wire which is indicated with the thick solid line in the drawings). In the example of FIG. 26, the phase belt group 13B (an example of the first phase belt group), of which the winding orders are 1 to 5, of the two-layer unit 12 in the first and second layers and the phase belt group 13B (an example of the second phase belt group), of which the winding orders are 6 to 10, of the two-layer unit 12 in the third and fourth layers are electrically connected in series to each other with the use of conductive wire (connecting wire which is indicated with the thick solid line in the drawing). And the phase belt group 13B (an example of the first phase belt group), of which the winding orders are 6 to 10, of the two-layer unit 12 in the first and second layers and the phase belt group 13B (an example of the second phase belt group), of which the winding orders are 1 to 5, of the two-layer unit 12 in the third and fourth layers are electrically connected in series to each other with the use of conductive wire (connecting wire which is indicated with the thick solid line in the drawing).

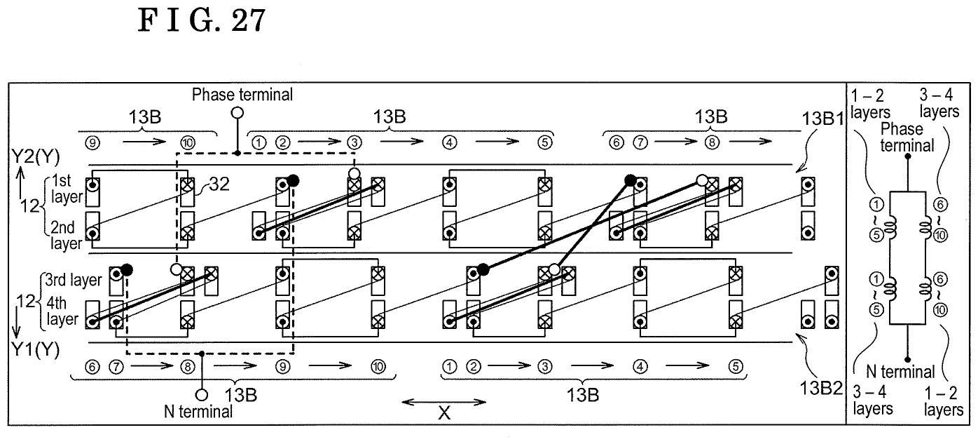

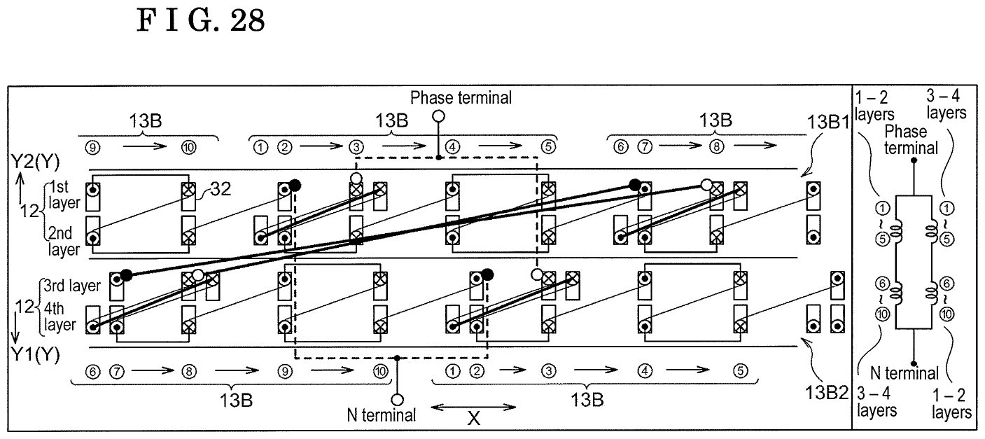

In the example of FIG. 27, the phase belt group 13B (an example of the first phase belt group), of which the winding orders are 1 to 5, of the two-layer unit 12 in the first and second layers and the phase belt group 13B (an example of the second phase belt group), of which the winding orders are 1 to 5, of the two-layer unit 12 in the third and fourth layers are electrically connected in series to each other with the use of conductive wire (connecting wire which is indicated with the thick solid line in the drawing). And the phase belt group 13B (an example of the second phase belt group), of which the winding orders are 6 to 10, of the two-layer unit 12 in the third and fourth layers and the phase belt group 13B (an example of the first phase belt group), of which the winding orders are 6 to 10, of the two-layer unit 12 in the first and second layers are electrically connected in series to each other with the use of conductive wire (connecting wire which is indicated with the thick solid line in the drawing). In the example of FIG. 28, the phase belt group 13B (an example of the first phase belt group), of which the winding orders are 1 to 5, of the two-layer unit 12 in the first and second layers and the phase belt group 13B (an example of the second phase belt group), of which the winding orders are 6 to 10, of the two-layer unit 12 in the third and fourth layers are electrically connected in series to each other with the use of conductive wire (connecting wire which is indicated with the thick solid line in the drawing). And the phase belt group 13B (an example of the first phase belt group), of which the winding orders are 1 to 5, of the two-layer unit 12 in the third and fourth layers and the phase belt group 13B (an example of the second phase belt group), of which the winding orders are 6 to 10, of the two-layer unit 12 in the first and second layers are electrically connected in series to each other with the use of conductive wire (connecting wire which is indicated with the thick solid line in the drawing).

That is, the pattern in which the two-layer unit 12 in the first and second layers and the two-layer unit 12 in the third and fourth layers are connected in series to each other includes four ways in total as follows. Two ways are illustrated in FIGS. 25 and 26 in which the two winding ends of the phase belt groups 13B in the first and second layers and the two winding starts of the phase belt groups 13B in the third and fourth layers are connected in series, respectively. The other two ways are illustrated in FIGS. 27 and 28 in which the winding start and the winding end of the phase belt groups 13B in the first and second layers and the winding end and the winding start of the phase belt groups 13B in the third and fourth layers are electrically connected in series, respectively.

In the example of FIG. 25, the winding end of the phase belt group 13B whose winding orders are 1 to 5 and which is in the first and second layers (or the phase belt group 13B whose winding orders are 6 to 10 and which is in the first and second layers), and the winding start of the phase belt group 13B whose winding orders are 1 to 5 and which is in the third and fourth layers (or the phase belt group 13B whose winding orders are 6 to 10 and which is in the third and fourth layers) that is shifted or offset from the above-described winding end in the direction opposite to the development direction by four slots are electrically connected to each other. On the other hand, in the example of FIG. 26, the winding end of the phase belt group 13B whose winding orders are 1 to 5 and which is in the first and second layers (or the phase belt group 13B whose winding orders are 6 to 10 and which is in the first and second layers), and the winding start of the phase belt group 13B whose winding orders are 6 to 10 and which is in the third and fourth layers (or the phase belt group 13B whose winding orders are 1 to 5 and which is in the third and fourth layers) that is shifted or offset from the above-described winding end in the development direction by eleven slots are electrically connected to each other.

In the examples of FIGS. 25 and 26, the winding start of the phase belt group 13B whose winding orders are 1 to 5 and which is in the first and second layers, and the winding start of the phase belt group 13B whose winding orders are 6 to 10 and which is in the first and second layers are electrically connected to each other with the use of the conductive wire (phase terminal connecting wire which is indicated with thick dashed line in the drawing), thereby forming a phase terminal. In addition, the winding end of the phase belt group 13B whose winding orders are 1 to 5 and which is in the third and fourth layers, and the winding end of the phase belt group 13B whose winding orders are 6 to 10 and that is in the third and fourth layers are electrically connected to each other with the use of the conductive wire (phase terminal connecting wire which is indicated with another thick dashed line in the drawing), thereby forming a neutral point (N terminal). That is, one phase terminal is configured by electrically connecting the plural first phase belt groups to each other and the other terminal is configured by electrically connecting the plural second phase belt groups to each other. Thus, it does not occur that the first phase belt group and the second phase belt group are electrically connected to each other to form one phase terminal or the other phase terminal. Accordingly, the points or portions at which the phase terminal connecting wire that connects the first phase belt group and the second phase belt group to each other intersects with other connecting wire are less (the four points or portions in the example of FIG. 25), and the intersection may also be prevented.

On the other hand, in the examples of FIGS. 27 and 28, the winding start of the phase belt group 13B in the first and second layers whose winding orders are 1 to 5, and the winding start of the phase belt group 13B that is in the third and fourth layers and whose winding orders are 6 to 10 (or the phase belt group 138 that is in the third and fourth layers and whose winding orders are 1 to 5) are electrically connected to each other with the use of the conductive wire (the phase terminal connecting wire which is indicated with a thick dashed line in the drawing), thereby forming a phase terminal. In addition, the winding end of the phase belt group 13B in the first and second layers whose winding orders are 6 to 10 and the winding end of the phase belt group 13B in the third and fourth layers whose winding orders are 1 to 5 (or the phase belt group 13B in the third and fourth layers whose winding orders are 6 to 10) are electrically connected to each other with the use of conductive wire (the phase terminal connecting wire which is indicated with another thick dashed line in the drawing), thereby forming a neutral point (N terminal). As a result, the points or portions at which the phase terminal connecting wire intersects with other connecting wire are increased (the eight points or portions in the example of FIG. 27) compared to the examples of FIGS. 25 and 26. In addition, the two connecting wires electrically connecting the phase belt group 13B in the first and second layers and the phase belt group 13B in the third and fourth layers directly to each other intersect with each other. Consequently, according to the examples of FIGS. 27 and 28, it is more difficult to prevent the intersection and the assembly performance is lower, compared to the examples of FIGS. 25 and 26. In addition, according to the examples of FIGS. 27 and 28, the connecting wire needs to be stacked on the coil ends 11b, which leads to increase in the size of the motor M. In consequence, at the motor M including the parallel connection, it is ideal that the plural first phase belt groups are electrically connected to form one phase terminal and the plural second phase belt groups are electrically connected to form another phase terminal.

The motor M described in the aforementioned embodiment is not limited to the three-phase alternating current synchronous electric motor, and may be an alternating current electric motor, an induction motor and/or a synchronous electric motor that include two or more phases, for example.

The disclosure is applicable to a rotating electrical machine including fractional slot configuration in which the number of slots of a stator per pole per phase is a fraction.

According to the aforementioned embodiment, the motor M (i.e., the rotating electrical machine) includes the stator 3 including the plural slots 32 on which the winding (i.e., the conductive wire) is wound, and the rotor 2 facing the stator 3 and including the plural permanent magnets (i.e., the magnetic poles) 22, wherein the motor M is configured of the fractional slot in which the denominator of the irreducible fraction obtained by dividing the number of the slots 32 of the stator 3 by the number of phases and the number of the permanent magnets 22 of the rotor 2 is equal to or greater than four, and the ratio of magnitude of magnetomotive force of each phase is even in the respective poles of the permanent magnets 22 of the rotor 2.

According to the above-described configuration, the ratio of magnitude of magnetomotive force of each phase is even in the respective poles of the magnetic poles 22 of the rotor 2. Thus, it is less likely that the exciting force of the spatial deformation mode including the low-order which is lower compared to the number of poles of the rotor 2 occurs in the range of the low number of revolutions. Accordingly, the noise and vibration in the low-rotation range due to the low-order spatial deformation mode of the stator 3 can be reduced.

According to the aforementioned embodiment, the rotating electrical machine M is configured of the distributed winding in which the irreducible fraction is greater than one and which includes the predetermined coil pitch. The two-layer unit 12 includes two layers of the coil sides 11a accommodated in the slots 32 in the radial direction Y of the rotor 2. In the two-layer unit 12, a group of the coil sides 11a which include same phase and same direction of the electric current in each pole and which are accommodated in one of the slots 32 or in the plural slots 32 adjacent to each other corresponds to the phase belt 13. The plural phase belts 13 form the mixed coil 1 formed in a manner that the phase belts 13 are stacked up in the radial direction Y while each of the plural phase belts 13 is shifted in the circumferential direction X of the rotor 2 by the predetermined number of the slots 32. In the mixed coil 1, a group of the coil sides 11a which are accommodated in the plural slots 32 that are continuously adjacent to each other in the circumferential direction X and which include the same phase and same direction of electric current corresponds to the mixed phase belt 13A, and the plural mixed phase belts 13A include the same number of coil sides 11a as each other.

According to the above-described configuration, for example, in a case of four poles and fifteen slots, in the two-layer unit 12, the ratio of magnitude of magnetomotive force generated by the coil sides 11a which are accommodated in the plural slots 32 continuously adjacent to each other in the circumferential direction X of the rotor 2 and which include the same phase and the same direction of electric current changes in such a manner of 3:2:2:3 in the phase belt 13, while the above-described ratio of magnitude of magnetomotive force changes in such a manner of 5:5:5:5 in the mixed phase belt 13A.

That is, the plural phase belts 13 are configured in the mixed manner so that the ratio of magnitude of magnetomotive force generated by the plural coil sides 11a forming the mixed phase belt 13A is even at respective poles of the magnetic poles 22 of the rotor 2. As a result, the magnetomotive force generated upon electrification of winding is even, and it is less likely that the exciting force of the spatial deformation mode including the low-order that is lower than the number of poles of the rotor 2 occurs. Accordingly, the noise and vibration in the low-rotation range due to the low-order space deformation mode of the stator 3 can be reduced.

According to the aforementioned embodiment, the denominator of the irreducible fraction corresponds to an even number, and the number of layers of the plurality of phase belts 13 stacked up in the radial direction corresponds to the value obtained by dividing the denominator by two.

According to the above-described configuration, when the denominator of the irreducible fraction is the even number, the number of layers of the plural phase belts 13 stacked in the radial direction Y corresponds to the value obtained by dividing the denominator by two. Therefore, the number, which is in the mixed manner, of the layers accommodated in each slot 32 can be reduced as much as possible. As a result, the noise and vibration can be reduced without making the distributed winding configuration of the winding to each slot 32 complicated. Consequently, it can be prevented that a manufacturing cost of the motor M and a size of the motor M increases.

According to the aforementioned embodiment, the predetermined number of slots 32 corresponds to the integer value obtained by doubling the nearest integer that is nearest to the number of slots 32 per pole, the number of slots 32 per pole is obtained by multiplying the irreducible fraction by the number of phases.

According to the above-described configuration, the plural mixed phase belts 13A including the same number of coil sides 11a as each other can be formed, while the increase of the width, in the circumferential direction X, of the coil sides 11a of the mixed phase belts 13A is minimized. As a result, the inconvenience, in which the mixed phase belts 13A adjacent to each other in the circumferential direction X exert the influence of their exciting forces with each other, can be prevented, thereby restricting decrease in torque.

According to the aforementioned embodiment, the number of slots 32 per pole is obtained by multiplying the irreducible fraction by the number of phase, the subtracted value is obtained by subtracting the nearest integer that is nearest to the number of slots 32 per pole from the number of slots 32 per pole, in a case where the subtracted value is positive, the predetermined number of the slots 32 corresponds to the value obtained by adding one to the integer value obtained by doubling the nearest integer, and in a case where the subtracted value is negative, the predetermined number of the slots 32 corresponds to the value obtained by subtracting one from the integer value.

According to the above-described configuration, the plural mixed phase belts 13A including the same number of coil sides 11a as each other can be formed, while the increase of the width, in the circumferential direction X, of the of the coil sides 11a of the mixed phase belts 13A is minimized. As a result, the inconvenience, in which the mixed phase belts 13A adjacent to each other in the circumferential direction X exert the influence of their exciting forces with each other, can be prevented, thereby restricting the decrease in torque.

According to the aforementioned embodiment, in the layer phase belt 13a which is included in the phase belts 13 and in which the plural slots 32 are arranged to be adjacent to each other in the same layer, the winding start of the winding is provided at the slot 32 which is at the end of the layer phase belt 13a in the direction opposite to the development direction of the unit coil 11 from the winding start of the winding to the winding end of the winding.

According to the above-described configuration, when providing the winding start of the winding (i.e., the conductive wire) at the layer phase belt 13a, the winding start is provided at the slot 32, out of the plural slots 32 in the same layer, which is arranged at the end of the layer phase belt 13a in the direction opposite to the development direction of the unit coil 11. Thus, in one cycle from the winding start to the winding end of the same-phase coil, the arrangement width of the coil sides 11a in the circumferential direction X can be reduced, and thus an assembly jig can be reduced in size. In addition, in one cycle from the winding start to the winding end of the same-phase coil, the connecting wire connecting the slots 32 to each other at the bottom portion side of the slot 32 (that is, a side opposite to a rotor side) can be minimized (to zero or one). And thus, for example, in a case where the phases are assembled in turn from the rotor side, the interference of the connecting wires with each other is eliminated or reduced, thereby enhancing the assembly performance and reducing risk of short circuit.

According to the aforementioned embodiment, the denominator of the irreducible fraction is four, and the phase belt 13 is formed of the first phase belt 13 and the second phase belt 13 which are stacked up in the radial direction, the first serial phase belt 13B1 includes the plural first phase belts 13 all of which are electrically connected to each other in series, the second serial phase belt 13B2 includes the plural second phase belts 13 all of which are electrically connected to each other in series. The winding end of the first serial phase belt 13B1 and the winding start of the second serial phase belt 13B2 are electrically connected to each other, the winding start of the second serial phase belt 13B2 is shifted from the winding end of the first serial phase belt 13B1 in the direction opposite to the development direction by the coil pitch.

According to the above-described configuration, at the rotating electrical machine (the motor M) at which each phase includes therein the series connection configuration, the winding end of the first serial phase belt 13B1 and the winding start of the second serial phase belt 13B2 that is shifted from the winding end in the direction opposite to the development direction by the coil pitch are electrically connected to each other. As a result, the connecting wire connecting the winding end of the first serial phase belt 13B1 and the winding start of the second serial phase belt 13B2 can be made shortest or can be minimized, thereby preventing the interference with, for example, the connecting wire connecting between the phase belts 13 within the phase. Consequently, there is no need to stack the connecting wire in the axial direction Z of the motor M, thereby reducing the size of the motor M.

According to the aforementioned embodiment, the phase belts 13 include the outermost phase belt 13, 13B arranged at the outermost side in the radial direction Y and the innermost phase belt 13, 13B arranged at the innermost side in the radial direction Y. The plural outermost phase belts 13, 13B are in the range in which as many the magnetic poles 22 of the rotor 2 as the number obtained by multiplying the denominator of the irreducible fraction by the predetermined number are arranged to be adjacent to each other. The plural outmost phase belts 13, 13B in the range are connected to each other in series to form the first phase belt group 13B, and the plural of the first phase belt groups 13B are electrically connected to each other in parallel. The plural innermost phase belts 13, 13B are in a range in which as many the magnetic poles 22 of the rotor 2 as the number obtained by multiplying the denominator of the irreducible fraction by the predetermined number are arranged to be adjacent to each other. The plural innermost phase belts 13, 13B in the range are connected to each other in series to form the second phase belt group 13B, and the plural of the second phase belt groups 13B are electrically connected to each other in parallel. One of the plural first phase belt groups 13B and one of the plural second phase belt groups 13B are electrically connected to each other in series, and the plural first phase belt groups 13B are electrically connected to each other to configure the phase terminal and the plural second phase belt groups 138 are electrically connected to each other to configure the other phase terminal.

According to the above-described configuration, at the motor M at which each phase includes therein the parallel connection, the plural first phase belt groups 13B are electrically connected to each other to form the phase terminal and the plural second phase belt groups 13B are electrically connected to each other to form the other phase terminal. Thus, there is no need to electrically connect the first phase belt group 13B and the second phase belt group 13B to each other to form the phase terminal or the other phase terminal. Therefore, the phase terminal connecting wire which connects the first phase belt group 13B and the second phase belt group 13B to each other intersects with other connecting wire at less points or less portions, and the intersection can be possibly avoided. As a result, there is no need to stack the phase terminal connecting wire in the axial direction Z of the motor M, thereby allowing the motor M to be compact.

According to the aforementioned embodiment, the motor (i.e., a rotating electrical machine) M includes the stator 3 including the plural slots 32 on which the winding (i.e., the conductive wire) is wound, and the rotor 2 facing the stator 3 and including the plural permanent magnets (i.e., the magnetic poles) 22, wherein the motor M is configured of the fractional slot in which the denominator of the irreducible fraction obtained by dividing the number of the slots 32 of the stator 3 by the number of phases and the number of the permanent magnets 22 of the rotor 2 is equal to or greater than four, and the ratio of magnitude of magnetomotive force of each pole coil of each phase is even in the circumferential direction X of the rotor 2.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A rotating electrical machine comprising:
a stator including a plurality of slots on which conductive wire is wound; and
a rotor facing the stator and including a plurality of magnetic poles, wherein
the rotating electrical machine is configured of fractional slot in which a denominator of an irreducible fraction obtained by dividing a number of the slots of the stator by a number of phases and a number of the magnetic poles of the rotor is equal to or greater than four, and
ratio of magnitude of magnetomotive force of each phase is even in respective poles of the magnetic poles of the rotor.

2. The rotating electrical machine according to claim 1, wherein
the rotating electrical machine is configured of distributed winding in which the irreducible fraction is greater than one and which includes a predetermined coil pitch,
a two-layer unit includes two layers of coil sides accommodated in the slots in a radial direction of the rotor,
in the two-layer unit, a group of the coil sides which include same phase and same direction of an electric current in each pole and which are accommodated in one of the slots or in a plurality of the slots adjacent to each other corresponds to a phase belt,
a plurality of the phase belts forms a mixed coil formed in a manner that the phase belts are stacked up in the radial direction while each of the plurality of phase belts is shifted in a circumferential direction of the rotor by a predetermined number of the slots,
in the mixed coil, a group of the coil sides which are accommodated in a plurality of the slots that are continuously adjacent to each other in the circumferential direction and which include same phase and same direction of the electric current corresponds to a mixed phase belt, and
a plurality of the mixed phase belts includes a same number of coil sides as each other.

3. The rotating electrical machine according to claim 2, wherein
the denominator of the irreducible fraction corresponds to an even number, and
a number of layers of the plurality of phase belts stacked up in the radial direction corresponds to a value obtained by dividing the denominator by two.

4. The rotating electrical machine according to claim 3, wherein the predetermined number of slots corresponds to an integer value obtained by doubling a nearest integer that is nearest to a number of slots per pole, the number of slots per pole is obtained by multiplying the irreducible fraction by the number of phases.

5. The rotating electrical machine according to claim 4, wherein
in a layer phase belt which is included in the phase belts and in which a plurality of the slots is arranged to be adjacent to each other in a same layer, a winding start of the conductive wire is provided at the slot which is at an end of the layer phase belt in a direction opposite to a development direction of a unit coil from the winding start of the conductive wire to a winding end of the conductive wire.

6. The rotating electrical machine according to claim 5, wherein
the denominator of the irreducible fraction is four, and the phase belt is formed of a first phase belt and a second phase belt which are stacked up in the radial direction,
a first serial phase belt includes a plurality of the first phase belts all of which are electrically connected to each other in series,
a second serial phase belt includes a plurality of the second phase belts all of which are electrically connected to each other in series, and
a winding end of the first serial phase belt and a winding start of the second serial phase belt are electrically connected to each other, the winding start of the second serial phase belt is shifted from the winding end of the first serial phase belt in a direction opposite to the development direction by coil pitch.

7. The rotating electrical machine according to claim 2, wherein
in a layer phase belt which is included in the phase belts and in which a plurality of the slots is arranged to be adjacent to each other in a same layer, a winding start of the conductive wire is provided at the slot which is at an end of the layer phase belt in a direction opposite to a development direction of a unit coil from the winding start of the conductive wire to a winding end of the conductive wire.

8. The rotating electrical machine according to claim 7, wherein
the denominator of the irreducible fraction is four, and the phase belt is formed of a first phase belt and a second phase belt which are stacked up in the radial direction,
a first serial phase belt includes a plurality of the first phase belts all of which are electrically connected to each other in series,
a second serial phase belt includes a plurality of the second phase belts all of which are electrically connected to each other in series, and
a winding end of the first serial phase belt and a winding start of the second serial phase belt are electrically connected to each other, the winding start of the second serial phase belt is shifted from the winding end of the first serial phase belt in a direction opposite to the development direction by coil pitch.

9. The rotating electrical machine according to claim 3, wherein
a number of slots per pole is obtained by multiplying the irreducible fraction by the number of phases,
a subtracted value is obtained by subtracting a nearest integer that is nearest to the number of slots per pole from the number of slots per pole,
in a case where the subtracted value is positive, the predetermined number of the slots corresponds to a value obtained by adding one to an integer value obtained by doubling the nearest integer, and
in a case where the subtracted value is negative, the predetermined number of the slots corresponds to a value obtained by subtracting one from the integer value.

10. The rotating electrical machine according to claim 9, wherein
the phase belts include an outermost phase belt arranged at an outermost side in the radial direction and an innermost phase belt arranged at an innermost side in the radial direction,
a plurality of the outermost phase belts is in a range in which as many the magnetic poles of the rotor as a number obtained by multiplying the denominator of the irreducible fraction by a predetermined number are arranged to be adjacent to each other, the plurality of the outmost phase belts in the range are connected to each other in series to form a first phase belt group, a plurality of the first phase belt groups are electrically connected to each other in parallel,
a plurality of the innermost phase belts is in a range in which as many the magnetic poles of the rotor as a number obtained by multiplying the denominator of the irreducible fraction by a predetermined number are arranged to be adjacent to each other, the plurality of the innermost phase belts in the range are connected to each other in series to form a second phase belt group, a plurality of the second phase belt groups are electrically connected to each other in parallel,
one of the plurality of the first phase belt groups and one of the plurality of the second phase belt groups are electrically connected to each other in series, and
the plurality of first phase belt groups are electrically connected to each other to configure a phase terminal and the plurality of second phase belt groups are electrically connected to each other to configure the other phase terminal.

11. The rotating electrical machine according to claim 3, wherein
in a layer phase belt which is included in the phase belts and in which a plurality of the slots is arranged to be adjacent to each other in a same layer, a winding start of the conductive wire is provided at the slot which is at an end of the layer phase belt in a direction opposite to a development direction of a unit coil from the winding start of the conductive wire to a winding end of the conductive wire.

12. The rotating electrical machine according to claim 11, wherein
the denominator of the irreducible fraction is four, and the phase belt is formed of a first phase belt and a second phase belt which are stacked up in the radial direction,
a first serial phase belt includes a plurality of the first phase belts all of which are electrically connected to each other in series,
a second serial phase belt includes a plurality of the second phase all of which are electrically connected to each other in series, and
a winding end of the first serial phase belt and a winding start of the second serial phase belt are electrically connected to each other, the winding start of the second serial phase belt is shifted from the winding end of the first serial phase belt in a direction opposite to the development direction by coil pitch.

13. The rotating electrical machine according to claim 4, wherein
the phase belts include an outermost phase belt arranged at an outermost side in the radial direction and an innermost phase belt arranged at an innermost side in the radial direction,
a plurality of the outermost phase belts is in a range in which as many the magnetic poles of the rotor as a number obtained by multiplying the denominator of the irreducible fraction by a predetermined number are arranged to be adjacent to each other, the plurality of the outmost phase belts in the range are connected to each other in series to form a first phase belt group, a plurality of the first phase belt groups are electrically connected to each other in parallel,
a plurality of the innermost phase belts is in a range in which as many the magnetic poles of the rotor as a number obtained by multiplying the denominator of the irreducible fraction by a predetermined number are arranged to be adjacent to each other, the plurality of the innermost phase belts in the range are connected to each other in series to form a second phase belt group, a plurality of the second phase belt groups are electrically connected to each other in parallel,
one of the plurality of the first phase belt groups and one of the plurality of the second phase belt groups are electrically connected to each other in series, and
the plurality of first phase belt groups are electrically connected to each other to configure a phase terminal and the plurality of second phase belt groups are electrically connected to each other to configure the other phase terminal.

14. The rotating electrical machine according to claim 5, wherein
the phase belts include an outermost phase belt arranged at an outermost side in the radial direction and an innermost phase belt arranged at an innermost side in the radial direction,
a plurality of the outermost phase belts is in a range in which as many the magnetic poles of the rotor as a number obtained by multiplying the denominator of the irreducible fraction by a predetermined number are arranged to be adjacent to each other, the plurality of the outmost phase belts in the range are connected to each other in series to form a first phase belt group, a plurality of the first phase belt groups are electrically connected to each other in parallel,
a plurality of the innermost phase belts is in a range in which as many the magnetic poles of the rotor as a number obtained by multiplying the denominator of the irreducible fraction by a predetermined number are arranged to be adjacent to each other, the plurality of the innermost phase belts in the range are connected to each other in series to form a second phase belt group, a plurality of the second phase belt groups are electrically connected to each other in parallel,
one of the plurality of the first phase belt groups and one of the plurality of the second phase belt groups are electrically connected to each other in series, and
the plurality of first phase belt groups are electrically connected to each other to configure a phase terminal and the plurality of second phase belt groups are electrically connected to each other to configure the other phase terminal.

15. The rotating electrical machine according to claim 2, wherein
the phase belts include an outermost phase belt arranged at an outermost side in the radial direction and an innermost phase belt arranged at an innermost side in the radial direction,
a plurality of the outermost phase belts is in a range in which as many the magnetic poles of the rotor as a number obtained by multiplying the denominator of the irreducible fraction by a predetermined number are arranged to be adjacent to each other, the plurality of the outmost phase belts in the range are connected to each other in series to form a first phase belt group, a plurality of the first phase belt groups are electrically connected to each other in parallel,
a plurality of the innermost phase belts is in a range in which as many the magnetic poles of the rotor as a number obtained by multiplying the denominator of the irreducible fraction by a predetermined number are arranged to be adjacent to each other, the plurality of the innermost phase belts in the range are connected to each other in series to form a second phase belt group, a plurality of the second phase belt groups are electrically connected to each other in parallel,
one of the plurality of the first phase belt groups and one of the plurality of the second phase belt groups are electrically connected to each other in series, and
the plurality of first phase belt groups are electrically connected to each other to configure a phase terminal and the plurality of second phase belt groups are electrically connected to each other to configure the other phase terminal.

16. The rotating electrical machine according to claim 7, wherein
the phase belts include an outermost phase belt arranged at an outermost side in the radial direction and an innermost phase belt arranged at an innermost side in the radial direction,
a plurality of the outermost phase belts is in a range in which as many the magnetic poles of the rotor as a number obtained by multiplying the denominator of the irreducible fraction by a predetermined number are arranged to be adjacent to each other, the plurality of the outmost phase belts in the range are connected to each other in series to form a first phase belt group, a plurality of the first phase belt groups are electrically connected to each other in parallel,
a plurality of the innermost phase belts is in a range in which as many the magnetic poles of the rotor as a number obtained by multiplying the denominator of the irreducible fraction by a predetermined number are arranged to be adjacent to each other, the plurality of the innermost phase belts in the range are connected to each other in series to form a second phase belt group, a plurality of the second phase belt groups are electrically connected to each other in parallel,
one of the plurality of the first phase belt groups and one of the plurality of the second phase belt groups are electrically connected to each other in series, and
the plurality of first phase belt groups are electrically connected to each other to configure a phase terminal and the plurality of second phase belt groups are electrically connected to each other to configure the other phase terminal.

17. The rotating electrical machine according to claim 3, wherein
the phase belts include an outermost phase belt arranged at an outermost side in the radial direction and an innermost phase belt arranged at an innermost side in the radial direction,
a plurality of the outermost phase belts is in a range in which as many the magnetic poles of the rotor as a number obtained by multiplying the denominator of the irreducible fraction by a predetermined number are arranged to be adjacent to each other, the plurality of the outmost phase belts in the range are connected to each other in series to form a first phase belt group, a plurality of the first phase belt groups are electrically connected to each other in parallel,
a plurality of the innermost phase belts is in a range in which as many the magnetic poles of the rotor as a number obtained by multiplying the denominator of the irreducible fraction by a predetermined number are arranged to be adjacent to each other, the plurality of the innermost phase belts in the range are connected to each other in series to form a second phase belt group, a plurality of the second phase belt groups are electrically connected to each other in parallel,
one of the plurality of the first phase belt groups and one of the plurality of the second phase belt groups are electrically connected to each other in series, and
the plurality of first phase belt groups are electrically connected to each other to configure a phase terminal and the plurality of second phase belt groups are electrically connected to each other to configure the other phase terminal.

18. The rotating electrical machine according to claim 11, wherein
the phase belts include an outermost phase belt arranged at an outermost side in the radial direction and an innermost phase belt arranged at an innermost side in the radial direction,
a plurality of the outermost phase belts is in a range in which as many the magnetic poles of the rotor as a number obtained by multiplying the denominator of the irreducible fraction by a predetermined number are arranged to be adjacent to each other, the plurality of the outmost phase belts in the range are connected to each other in series to form a first phase belt group, a plurality of the first phase belt groups are electrically connected to each other in parallel,
a plurality of the innermost phase belts is in a range in which as many the magnetic poles of the rotor as a number obtained by multiplying the denominator of the irreducible fraction by a predetermined number are arranged to be adjacent to each other, the plurality of the innermost phase belts in the range are connected to each other in series to form a second phase belt group, a plurality of the second phase belt groups are electrically connected to each other in parallel,
one of the plurality of the first phase belt groups and one of the plurality of the second phase belt groups are electrically connected to each other in series, and
the plurality of first phase belt groups are electrically connected to each other to configure a phase terminal and the plurality of second phase belt groups are electrically connected to each other to configure the other phase terminal.

19. A rotating electrical machine comprising:
a stator including a plurality of slots on which conductive wire is wound; and
a rotor facing the stator and including a plurality of magnetic poles, wherein
the rotating electrical machine is configured of fractional slot in which a denominator of an irreducible fraction obtained by dividing a number of the slots of the stator by a number of phases and a number of the magnetic poles of the rotor is equal to or greater than four, and
ratio of magnitude of magnetomotive force of each pole coil of each phase is even in a circumferential direction of the rotor.
